(19) United States
(12) Patent Application Publication
(10) Pub. No.: US 2026/0320112 A1
(43) Pub. Date: Oct. 15, 2026

(54) MACHINE-LEARNING FRAMEWORK FOR GENERATING RECORDS FROM USER-GENERATED CONTENT

(71) Applicant: Ancestry.com Operations Inc., Lehi, UT (US)

(72) Inventors: Jack Reese, Lindon, UT (US); Taylor Neil Archibald, Provo, UT (US); Siteng Chen, Provo, UT (US); Suraj Subraveti, San Francisco, CA (US); Maria Antonia Fabiano, Germantown, TN (US); Kalyan Chakravarthi Murahari, Walnut Creek, CA (US); Vishwajeet Vijay Paradkar, Fremont, CA (US)

(21) Appl. No.: 19/643,157

(22) Filed: Apr. 9, 2026

Related U.S. Application Data
(60) Provisional application No. 63/786,480, filed on Apr. 10, 2025.

(51) Int. Cl. G06F 16/535; G06F 16/55; G06V 10/764; G06V 30/19; G06V 30/22; G06V 30/413; G06V 30/414

(52) U.S. Cl. CPC G06F 16/535; G06F 16/55; G06V 10/764; G06V 30/19173; G06V 30/22; G06V 30/413; G06V 30/414

(57) ABSTRACT

The present disclosure relates to systems, non-transitory computer-readable media, and methods for processing user-generated genealogical content. In particular, in one or more embodiments, the disclosed systems receive digital images reflecting user-generated genealogical-content items and utilize a content-classification model to generate record classifications and route the digital images to one or more specialized processing pipelines to extract genealogical data from the digital images. In some embodiments, the disclosed systems use a pipeline comprised of an ensemble of models, including language-specific and document-specific models, to extract genealogical data based on the record classification. In other embodiments, the disclosed systems use a large language model to extract genealogical data based on the record classification. Further, in one or more embodiments, the disclosed systems generate genealogical records using the extracted genealogical data. In addition, in some cases, the disclosed systems perform layout analysis to detect document regions and reading order for the digital image.

### CROSS-REFERENCE TO RELATED APPLICATIONS

This application claims priority to and the benefit of U.S. Provisional Patent Application No. 63/786,480, filed on Apr. 10, 2025, which is incorporated herein by reference in its entirety.

### BACKGROUND

Advancements in computing devices and networking technology have given rise to a variety of innovations in cloud-based genealogical data storage, sharing, and generation. For example, online historical-content systems can provide access to digital genealogical records across devices all over the world. Online historical-content systems can also analyze genealogical records for specific user accounts to generate links or relationships between genealogical records and user accounts. Despite these advances, however, existing systems continue to exhibit a number of disadvantages, particularly in terms of flexibility, accuracy, and efficiency.

As just suggested, certain existing systems are inflexible. While some existing systems allow users to upload images of user-generated content, including records, photos, and other content, such systems provide limited (if any) functional integration of user-generated content for backend systems and record analysis. For the most part, existing systems restrict user-generated content and prevent its use as reliable genealogical data for genealogical trees or record databases, instead only providing functions for users to share and implement uploaded images in their personal user accounts. Indeed, user-generated content varies widely in handwriting styles, languages, and other aspects which can differ across geographic regions, communities, time periods, and/or content types (e.g., legal documents, journal entries, birth certificates, photos, letters, and others). Due to this broad variability, in addition to the technical issues involved in processing the various kinds of user-generated content, many existing systems either cannot or elect not to use user-generated content as genealogical data sources.

Due at least in part to their inflexibilities, some existing systems are also inaccurate. In particular, because certain existing systems limit the function of user-generated content to saving and displaying uploaded images within a user account, the databases of these existing systems can be severely lacking. Indeed, some genealogical information is found only in user-generated content. As an example, there are several communities of peoples, such as Indigenous people, enslaved populations, or refugees, that lack comprehensive government records. For such groups, user-generated content may be the only surviving records, and ignoring or omitting such content invariably leads to inaccuracies (or incompleteness) of existing systems. Indeed, not only are the databases of existing systems lacking data, but downstream functions for generating various predictions and/or modifying genealogical trees in such systems is also less accurate as a result of its incomplete data. Furthermore, given the interconnectedness of people in pedigrees, with a historical person frequently being instantiated in a plurality of pedigrees (often without the owners of such pedigrees being aware of the duplicative instances of the historical person and the owners of the respective pedigrees), a cluster database which resolves duplicative instances of a historical person to a cluster to allow collaboration among pedigree owners and sharing of resources therebetween may be severely handicapped in its scope and effectiveness by the limitation of user-generated content to personal user accounts.

Moreover, existing systems are inefficient. As mentioned, existing systems are limited to displaying and sharing user-generated content between users. To convert information contained in the user-generated content into actionable, functional data, existing systems require users to generate and store digitized versions of user-generated content in recognized formats. Searching through and manually converting information in user-generated content into recognizable genealogical data requires excess numbers of user interactions that could otherwise be preserved or reduced with a more efficient system.

### SUMMARY

Embodiments of the present disclosure provide benefits and/or solve one or more of the foregoing or other problems in the art with systems, non-transitory computer-readable media, and methods for processing heterogeneous user-generated genealogical content using a coordinated set of machine-learning models to generate structured genealogical data. In some embodiments, the disclosed systems utilize a front-end classification model to classify and dynamically route user-generated-content items to one or more machine-learning models configured to extract structured genealogical content. For example, the disclosed systems can route the user-generated genealogical-content item to a processing pipeline comprising an ensemble of models that perform specialized tasks for extracting genealogical data, such as transcription models configured for multiple languages and natural language processing models that extract entities, relationships, and attributes from transcribed content. In some embodiments, the disclosed systems alternatively, or additionally, route user-generated genealogical content items to a large language model to extract structured genealogical content from user-generated-content items. In one or more embodiments, the disclosed systems also utilize layout analysis models to generate layout data identifying hierarchical text regions and preserving reading order, and where the various machine-learning models of the pipeline and/or the large language model utilize the layout data to inform extraction of genealogical data. Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a user-generated-content system can operate in accordance with one or more embodiments.

FIG. 2 illustrates an example diagram of an overview of a user-generated-content system extracting genealogical data from user-generated content in accordance with one or more embodiments.

FIG. 3 illustrates a diagram of a user-generated-content system using a digital-image router to select a machine-learning model to use when extracting genealogical data from a digital image in accordance with one or more embodiments.

FIG. 4 illustrates a diagram of a user-generated-content system using a genealogical-data-extracting machine-learning model that employs a series of machine-learning models to perform specific tasks in order to extract genealogical data from a digital image uploaded by a client device in accordance with one or more embodiments.

FIG. 5 illustrates a diagram of a user-generated-content system using a genealogical-data-extracting large language model to extract genealogical data from a digital image in accordance with one or more embodiments.

FIGS. 6A-6D illustrate a user-generated-content system using a layout-extracting machine-learning model to generate layout data in accordance with one or more embodiments.

FIGS. 7A-7D illustrate example graphical user interfaces of a user-generated-content system modifying genealogical trees using genealogical data extracted from user-generated genealogical-content items in accordance with one or more embodiments.

FIG. 8 illustrates a flowchart of a series of acts for using various machine-learning models to extract genealogical data from user-generated genealogical-content items and generating genealogical records comprising the genealogical data in accordance with one or more embodiments.

FIG. 9 illustrates a tree database and a cluster database of a genealogical-data system in accordance with one or more embodiments.

FIG. 10 illustrates a block diagram of an architecture of an example computing server for a genealogical-data system in accordance with some embodiments.

FIG. 11 illustrates a block diagram of an example computing device for implementing one or more embodiments of the present disclosure.

FIG. 12 illustrates an example environment for a genealogical-data system in accordance with one or more embodiments.

### DETAILED DESCRIPTION

This disclosure describes one or more embodiments of a user-generated-content system that utilizes machine learning to generate genealogical records (as reliable data sources) from a user-generated genealogical-content item. In particular, the user-generated-content system utilizes a user-generated-content processing pipeline or framework that includes multiple stages, such as: 1) classifying a digital image as user-generated content using a user-generated-content classifier, 2) processing the digital image to determine a record classification for the user-generated content in the digital image using a content-classification machine-learning model, 3) extracting a layout for the user-generated content in the digital image, and 4) extracting genealogical data from the digital image using a genealogical-data-extracting model. The user-generated-content system can utilize a content-classification machine-learning model to generate a record classification indicating a record type for a user-generated genealogical-content item. Further, the user-generated-content system can utilize a genealogical-data-extracting machine-learning model to extract genealogical data from the user-generated genealogical-content item. In some cases, the user-generated-content system utilizes large language models (LLMs) and/or other machine-learning models as part of the framework to perform various data-extraction or other tasks in the pipeline.

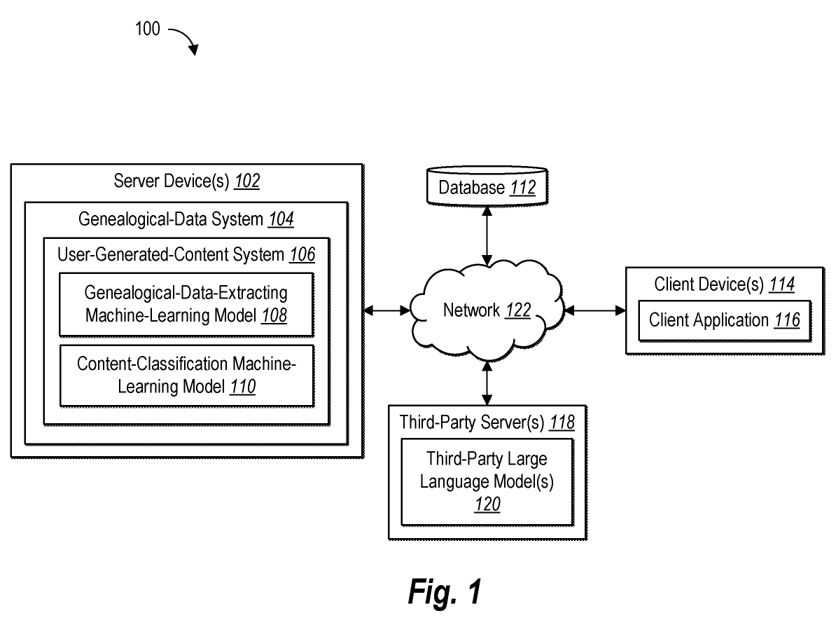

Turning now to the figures, FIG. 1 illustrates an example overview of a user-generated-content system. For example, FIG. 1 illustrates a diagram of an environment 100 in which a user-generated-content system 106 can operate in accordance with one or more embodiments. An overview of the user-generated-content system 106 is provided in relation to FIG. 1. Thereafter, a more detailed description of the components and processes of the user-generated-content system 106 is provided in relation to the subsequent figures.

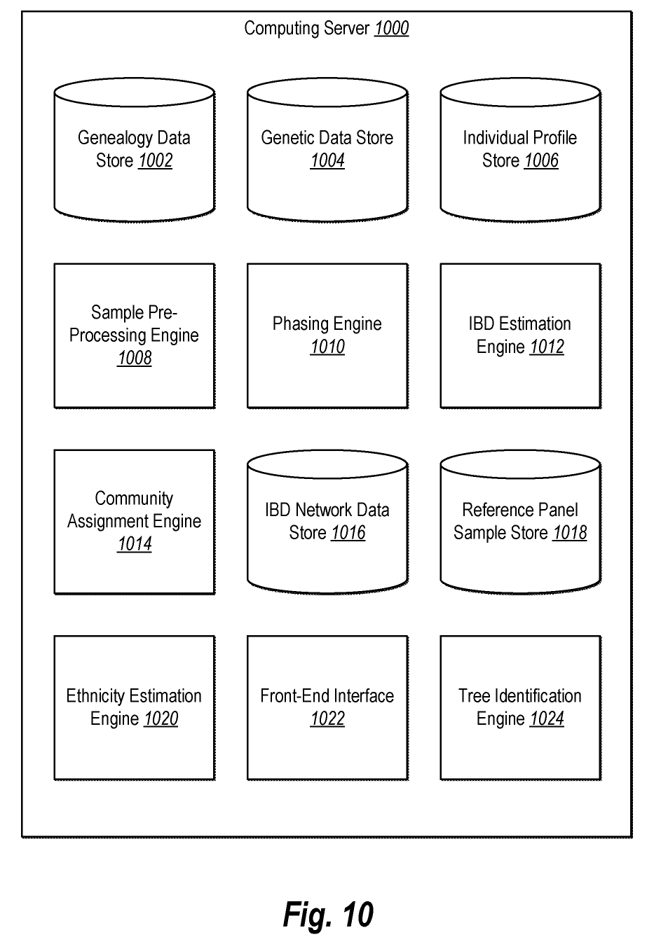

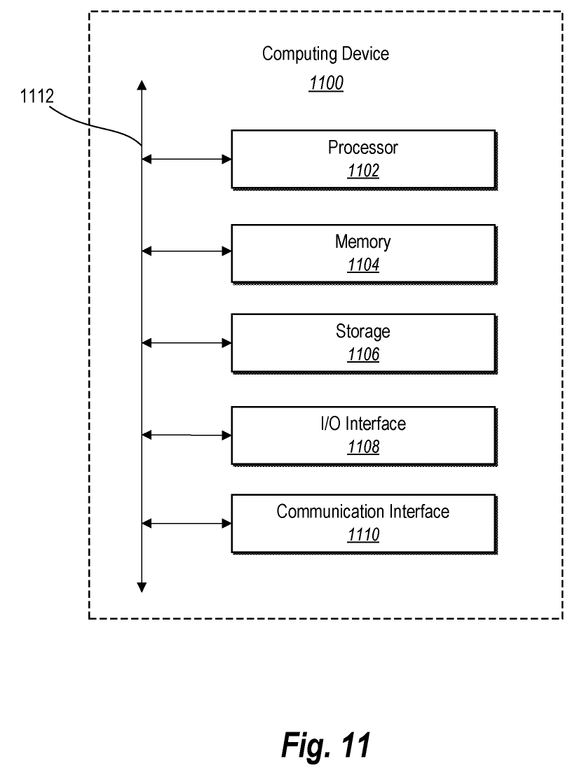

As shown, the environment 100 includes server device(s) 102, database 112, client device(s) 114, and third-party server(s) 118. Each of the components of the environment 100 can communicate via network 122 and network 122 may be any suitable network over which computing devices can communicate. Example networks are discussed in more detail in relation to FIGS. 10-11.

As mentioned above, the environment 100 includes client device(s) 114. The client device(s) 114 can be one of a variety of computing devices, including a smartphone a tablet, a smart television, a desktop computer, a laptop computer, a virtual reality device, an augmented reality device, or another computing device as described in relation to FIGS. 10-11. The client device(s) 114 can communicate with the server device(s) 102 via network 122. For example, the client device(s) 114 can receive user input from a user interacting with client device(s) 114 (e.g., via the client application 116) to, for instance, receive user interactions with digital images. In addition, the user-generated-content system 106 or the server device(s) 102 can receive information relating to various interactions with user interface elements based on the input received by the client device(s) 114.

As shown, the client device(s) 114 can include a client application 116. In particular, the client application 116 may be a web application, a native application installed on the client device(s) 114 (e.g., a mobile application, a desktop application, etc.), or a cloud-based application where all or part of the functionality is performed by the server device(s) 102. Based on instructions from the client application 116, the client device(s) 114 can present or display information, including a user interface for adding digital images to genealogical-data system 104. Using the client application 116, the client device(s) 114 can perform (or request to perform) various operations, such as uploading or capturing a digital image of user-generated content and/or displaying interfaces for genealogical records or genealogical trees modified by user-generated content.

As further illustrated in FIG. 1, the environment 100 includes the third-party server(s) 118 that host the third-party large language model(s) 120. In particular, the third-party large language model(s) 120 communicates with the server device(s) 102, client device(s) 114, and/or the database 112 for the user-generated-content system 106 to extract genealogical data from and/or generate a genealogical record for a digital image depicting a user-generated genealogical-content item. For example, the user-generated-content system 106 provides domain-specific language segments to the third-party large language model(s) 120, where the domain-specific language segments indicate data for generating results for various subcomponents. Indeed, the third-party large language model(s) 120 can include a machine-learning model powered by neural networks or other machine-learning architectures for generating responses to text queries. In some cases, the third-party large language model(s) 120 can refer to various third-party machine-learning models (e.g., ChatGPT, Lambda, Llama, BERT, RoBERTa, Turing-NLG, T5, XLNet). While third-party large language model(s) 120 are described, it will be appreciated that the disclosure is not limited thereto, but rather third-party server(s) 118 may additionally or alternatively utilize other machine learning techniques or modalities as suitable. Further, in embodiments, the large-language model(s) 120 are hosted on-prem on the server device(s) 102.

As illustrated in FIG. 1, the environment 100 also includes the server device(s) 102. The server device(s) 102 may generate, track, store, process, receive, and transmit electronic data, such genealogical records, genealogical trees, uploaded images of user-generated content, interactions with interface elements, and/or interactions between user accounts or client devices. For example, the server device(s) 102 may receive an indication from the client device(s) 114 of a user interaction adding a digital image to the genealogical-data system 104. In addition, the server device(s) 102 can transmit data to the client device(s) 114 in the form of a genealogical record generated from a digital image depicting a user-generated genealogical-content item added by the client device(s) 114. Indeed, the server device(s) 102 can communicate with the client device(s) 114 to send and/or receive data via network 122. In some implementations, the server device(s) 102 comprise(s) a distributed server where the server device(s) 102 include(s) a number of server devices distributed across the network 122 and located in different physical locations. The server device(s) 102 can comprise one or more content servers, application servers, container orchestration servers, communication servers, web-hosting servers, machine-learning servers, and other types of servers.

As shown in FIG. 1, the server device(s) 102 can also include the user-generated-content system 106 as part of the genealogical-data system 104. The genealogical-data system 104 can communicate with the client device(s) 114 to perform various functions associated with the client application 116, such as managing user accounts and/or identifying digital images. Indeed, genealogical-data system 104 can include a network-based smart cloud-storage system to manage, store, and maintain digital images and related data across numerous user accounts. In some embodiments, the user-generated-content system 106 and/or the genealogical-data system 104 utilize the database 112 to store and access information such as digital images of user-generated content and/or genealogical records derived from user-generated content. Further, the genealogical-data system 104 can facilitate sharing user-generated content between multiple user accounts within the genealogical-data system 104. Indeed, the genealogical-data system 104 facilitates sharing user-generated content between respective user accounts that are represented as nodes of a genealogical tree. Additional information regarding the genealogical-data system 104 is provided below with respect to FIG. 10.

As also shown in FIG. 1, the user-generated-content system 106 can house the genealogical-data-extracting machine-learning model 108. In one or more embodiments, the genealogical-data-extracting machine-learning model 108 includes multiple machine-learning models, where each machine-learning model is trained to perform specialized tasks in series (and/or in parallel) to extract genealogical data from digital images depicting user-generated genealogical-content item that client device(s) 114 add to the genealogical-data system 104. In some embodiments, genealogical-data-extracting machine-learning model 108 is a large language model that extracts genealogical data from a digital image depicting a user-generated content item. The genealogical-data-extracting machine-learning model 108 is housed within (or local to) the user-generated-content system 106 and the genealogical-data-extracting machine-learning model 108 can extract genealogical data and/or genealogical hints from digital images locally with the user-generated-content system 106 (or the genealogical-data system 104). While the genealogical-data-extracting machine-learning model 108 is described as being local to or housed within the user-generated-content system 106, it will be appreciated that the user-generated-content system 106 may be configured to cooperate with a non-local genealogical-data-extracting machine-learning model 108, in embodiments.

Further, the user-generated-content system 106 trains, maintains, and manages the workload of the genealogical-data-extracting machine-learning model 108, including the machine-learning models that work in series (and/or in parallel) as part of the genealogical-data-extracting machine-learning model 108 (e.g., as a genealogical-data-extracting pipeline 412).

In addition, as shown in FIG. 1, the user-generated-content system 106 can house the content-classification machine-learning model 110. In one or more embodiments, content-classification machine-learning model 110 is trained to classify digital images of user-generated genealogical content as belonging to a particular category or class, such as letters, journals, birth-marriage-death (BMD) records, newspaper clippings, immigration documents, or other user-generated content. In embodiments, the content-classification machine-learning model 110 is configured to perform a preliminary classification of digital images as being user-generated genealogical content, such that the digital images determined to be user-generated genealogical content may then be processed further to classify what particular type of user-generated content category the digital items are assignable to.

In some embodiments, content-classification machine-learning model 110 is a large language model that classifies digital images of user-generated genealogical content. The content-classification machine-learning model 110 is housed within (or local to) the user-generated-content system 106 and the user-generated-content system 106 can extract genealogical data and/or can generate genealogical hints from digital images locally with the user-generated-content system 106. Further, the user-generated-content system 106 trains, maintains, and manages the workload of the content-classification machine-learning model 110. While content-classification machine-learning model 110 is described as being local to or housed within the user-generated-content system 106, it will be appreciated that the user-generated-content system 106 may be configured to cooperate with a non-local content-classification machine-learning model 110, in embodiments.

Although FIG. 1 depicts the user-generated-content system 106 located on the server device(s) 102, in some implementations, the user-generated-content system 106 may be implemented by (e.g., located entirely or in part on) one or more other components of the environment 100. For example, the user-generated-content system 106 may be implemented as part of client device(s) 114 and/or a third-party system. As another example, the client device(s) 114 and/or a third-party system can download all or part of the user-generated-content system 106 for implementation independent of, or together with, the server device(s) 102.

In some implementations, though not illustrated in FIG. 1, the environment 100 may have a different arrangement of components and/or may have a different number or set of components altogether. For example, the client device(s) 114 may communicate directly with the user-generated-content system 106, bypassing network 122. The environment 100 may also include one or more third-party systems, each corresponding to a different data source. In addition, the environment 100 can include the database 112 located external to the server device(s) 102 (e.g., in communication via the network 122) or located on the server device(s) 102 and/or on the client device(s) 114.

As illustrated by the foregoing discussion, the present disclosure utilizes a variety of terms to describe features and benefits of the lifespan filter system. Additional detail is hereafter provided regarding the meaning of these terms as used in this disclosure. As used herein, the term “user-generated content” (or “user-generated genealogical-content item”) refers to content that is created by or originates with a user, such as a user of a genealogical research service, rather than generated by computer applications or digital platforms that have structured, controlled, or automated content-production processes. For example, user-generated content may include any digital image of any genealogical-content item that originates with a user—such as via an image-capture device associated with the user—as opposed to through an enterprise-curated pipeline or process, such as a batch of digitized records pertaining to a particular historical-record source or collection. User-generated content includes (digitized versions of) content that is created by hand (e.g., handwritten or hand-drawn). In some cases, user-generated content refers to digital content that is converted, digitized, or otherwise generated from handwritten or hand-drawn genealogical content. For example, user-generated content could include a digital image of a physical birth certificate, a digital image of a journal entry, a digital image of a letter, or a digital image of some other user-generated genealogical-content item that a user uploads to a digital platform such as a genealogical-data system. User-generated content may include a user-uploaded digital image of a photograph, such as a family photograph, a user-captured image of a historical record, such as a family-history book, or any other suitable user-originated genealogy-content item.

In one or more embodiments, the term “record classification” refers to a categorization of a user-generated genealogical-content item based on characteristics, attributes, or content of the user-generated genealogical-content item. A record classification can include a specific class that is assigned to a genealogical record based on image analysis of visual characteristics, visual attributes, or style of the user-generated genealogical-content item aligning with specifications for the specific class. In addition, a record classification indicates a distinction that can inform further processing of the user-generated genealogical-content item. In some embodiments, a record classification refers to a selection or prediction of a classification from a defined set of classifications. For example, labels for record classifications can include “BMD certificate” (e.g., birth certificate, death certificate, or marriage certificate), “letter”/“journal,” “foreign-language certificate” (e.g., French birth, marriage, or death certificates), or “other.” Said prediction may be generated by the content-classification machine-learning model 110.

Also, in some embodiments, the term “genealogical record” refers to a digital object or a digital file that includes information (e.g., genealogical information) interpretable by a computing device (e.g., a client device) and reflecting genealogical information. A genealogical record can include a file such as a digital text file, a digital image file, a digital audio file, a webpage, a website, a digital video file, a web file, a link, a digital document file, or some other type of file or digital object. In some embodiments, a genealogical record includes a digital item converted or derived from a user-generated genealogical-content item, such as a digital version of a BMD certificate, a digital version of a journal/letter, a digital version of a foreign-language certificate, a digital version of a newspaper article, a record hint (e.g., a stored genealogical record), a new-person hint (e.g., a node to add to a genealogical tree), or a member-tree hint (e.g., a prediction for correcting a node within a genealogical tree of a user account), among many other possibilities. It will be appreciated that while some embodiments are directed to genealogical records specifically, the features and advantages of embodiments of the disclosure are broadly applicable to other types and classes of digital content.

In addition, in one or more embodiments, the term “machine-learning model” refers to a computer algorithm or a collection of computer algorithms that automatically improve for a particular task through iterative outputs or predictions based on the use of data. For example, a machine-learning model can utilize one or more learning techniques to improve accuracy and/or effectiveness. Example machine-learning models include various types of neural networks, decision trees, support vector machines, linear regression models, and Bayesian networks.

Relatedly, in some embodiments, the term “neural network” refers to a machine-learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., genealogical data) based on a plurality of inputs provided to the neural network. In some cases, a neural network refers to an algorithm (or set of algorithms) that implements deep learning techniques to model high-level abstractions in data. A neural network can include various layers, such as an input layer, one or more hidden layers, and an output layer that each perform tasks for processing data. For example, a neural network can include a deep neural network, a convolutional neural network, a transformer neural network, a recurrent neural network (e.g., an LSTM), a graph neural network, or a generative adversarial neural network. Upon training, such a neural network may become a large language model.

Moreover, in one or more embodiments, the term “large language model” refers to a machine-learning model trained to perform computer tasks to generate or identify content items in response to trigger events (e.g., user interactions, such as text queries and button selections). In particular, a large language model can be a neural network (e.g., a deep neural network or a transformer neural network) with many parameters trained on large quantities of data (e.g., unlabeled text) using a particular learning technique (e.g., self-supervised learning). For example, a large language model can include parameters trained to generate outputs (e.g., layouts, classifications, and/or extracted genealogical data) based on prompts and/or to identify content items based on various contextual data, including graph information from a knowledge graph and/or historical user account behavior. In some cases, a large language model comprises various commercially available models such as, but not limited to, GPT (e.g., GPT 3.5, GPT 4, GPT 4o, GPT 4.5), Llama (e.g., Llama2-7B, Llama 3), BERT, Claude, or Cohere.

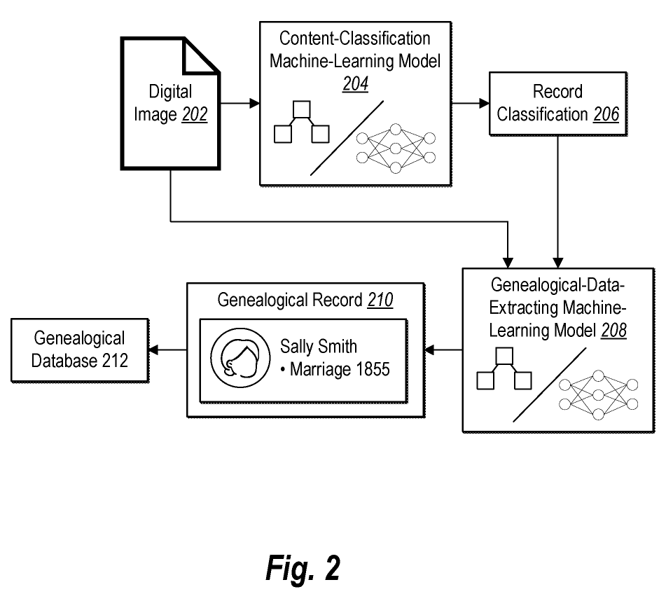

As previously mentioned, the user-generated-content system 106 utilizes a user-generated-content processing pipeline or framework that includes multiple stages to generate genealogical records from user-generated content. Among other stages, the user-generated-content system 106 utilizes a content-classification machine-learning model to generate a record classification for a digital image depicting user-generated content and uses a genealogical-data-extracting machine-learning model to generate a genealogical record for the user-generated content. FIG. 2 illustrates an example overview of extracting genealogical data from user-generated content in accordance with one or more embodiments. Additional detail regarding the various acts and processes introduced in relation to FIG. 2 is provided thereafter with reference to subsequent figures.

As shown, the user-generated-content system 106 receives a digital image 202. Specifically, the user-generated-content system 106 receives digital image 202 that depicts a user-generated genealogical-content item from a client device associated with a user account of genealogical-data system 104. For example, the user-generated-content system 106 can receive digital image 202 through a client device uploading the digital image 202 to the genealogical-data system 104 through an application (e.g., client application 116) of genealogical-data system 104. In embodiments, the user-generated-content system 106 can receive digital image 202 through an image-capture modality of the client device, such as by a user capturing an image, using the client device, of a genealogical-content item, such as an old family photo or a page from a family-history book.

As mentioned, digital image 202 depicts a user-generated genealogical-content item. More specifically, digital image 202 includes handwritten or hand-drawn records, documents, or narratives that correspond to the lineage, relationships, stories, or heritage of familial relationships. For example, digital image 202 can be an image representation of a hand-filled vital-record certificate, such as a birth certificate, death certificate, marriage certificate, or adoption certificate, or a handwritten record including genealogical information (e.g., letters or journals). In some cases, digital image 202 can include foreign-language certificates, such as French birth certificates, marriage certificates, or death certificates. Indeed, a client device may add digital image 202 to a genealogical-data system 104 in order to share and/or process content depicted in digital image 202. For instance, a user may desire to avail themselves of the functionalities of the genealogical-data system 104, such as handwriting recognition tools or facial-recognition tools.

As also shown in FIG. 2, the user-generated-content system 106 utilizes a content-classification machine-learning model 204 to generate a record classification 206 for the digital image 202. More specifically, in response to receiving digital image 202, the user-generated-content system 106 utilizes the content-classification machine-learning model 204 to generate the record classification 206 as an indication of a type of genealogical content depicted in digital image 202. The content-classification machine-learning model 204 analyzes pixels of the digital image 202 to determine the record classification 206 for digital image 202. For instance, the content-classification machine-learning model 204 identifies pixels depicting handwritten content laid out in a particular format or arrangement corresponding to the record classification 206. To determine an arrangement, the content-classification machine-learning model 204 can generate predicted region boundaries between pixel regions of the digital image 202, separating different sections or portions of handwritten content into respective regions. The content-classification machine-learning model 204 can thus determine the record classification 206 according to the region boundaries, indicating an arrangement within a threshold similarity of an arrangement for one of a predetermined set of record classifications. In embodiments, the content-classification machine-learning model 204 is configured to reject a digital image, e.g. by generating or assigning a “reject” label for the digital image, where, for example, the digital image is determined to have too-low resolution or other quality metrics (e.g. that cannot be resolved using an image-improvement or -enhancement modality) and/or whether the digital image is determined to pertain to non-genealogical content.

In some embodiments, the content-classification machine-learning model 204 performs classification at both a document level for the digital image 202 and/or at various sub-region levels of the digital image. For example, the user-generated-content system 106 may divide the digital image 202 into multiple regions corresponding to detected layout blocks or image coordinates. The content-classification machine-learning model 204 may classify each region independently to identify different content types within a single document, such as handwritten text regions, printed text regions, graphical regions, or table regions

In some cases, the content-classification machine-learning model 204 recognizes a particular language of the user-generated content as part of determining the record classification 206. Indeed, the content-classification machine-learning model 204 can include weights and parameters trained or tuned on examples of prelabeled user-generated content images (e.g., sample images whose record classification is known) depicting content in various languages and in various formats or arrangements. The content-classification machine-learning model 204 can thus generate the record classification 206 according to content language and/or content arrangement. The user-generated-content system 106 can generate record classifications 206, by generating, for example, a letter classification (or journal classification), a certificate classification, a foreign-certificate classification (e.g., French birth, marriage, or death certificates), or other classifications.

Additionally, as shown in FIG. 2, the user-generated-content system 106 utilizes a genealogical-data-extracting machine-learning model 208 to generate genealogical record 210. Specifically, the user-generated-content system 106 utilizes the genealogical-data-extracting machine-learning model 208 to extract genealogical data from digital image 202 and generate genealogical record 210. In some embodiments, the user-generated-content system 106 utilizes multiple genealogical-data-extracting machine-learning models to generate the genealogical record 210, where the output of one model may feed into another to form a record-generation pipeline. Indeed, the record classification 206 informs the user-generated-content system 106 in selecting or determining which downstream data-extraction models to use for generating the genealogical record 210 (e.g., as part of the genealogical-data-extracting machine-learning model 208). The user-generated-content system 106 can determine which model(s) to use for generating the genealogical record 210 according to the record classification 206, where certain models of the genealogical-data-extracting machine-learning model 208 are trained, tuned, or customized for particular types of user-generated content (e.g., certain record classifications).

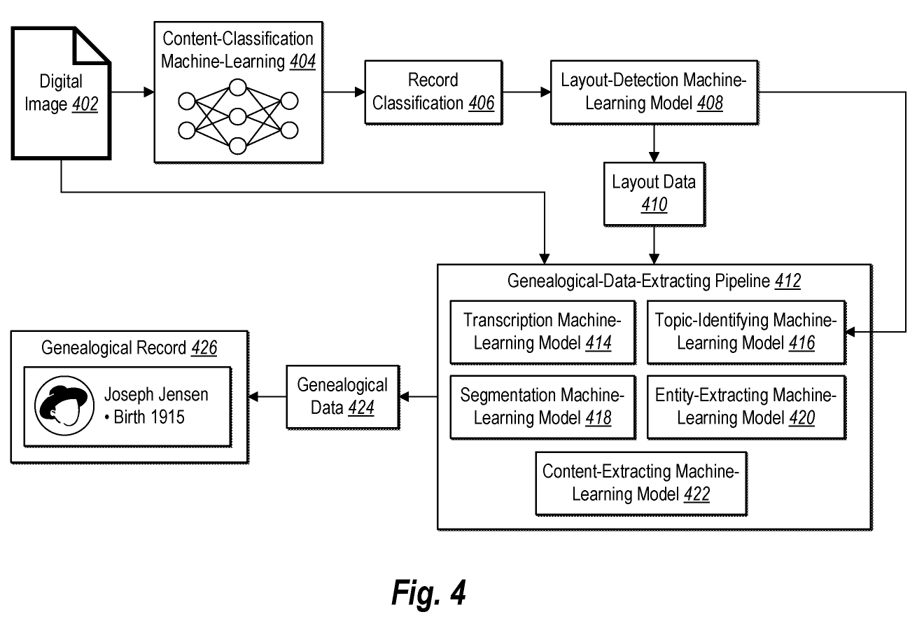

For example, the genealogical-data-extracting machine-learning model 208 can refer to (or be a part of) a set of multiple models in a genealogical-data-extracting pipeline, some working in series and others in parallel, to extract data from the digital image 202 according to the record classification 206. In some embodiments, the user-generated-content system 106 uses a layout-extraction model to extract or determine a layout of user-generated content depicted in the digital image 202. From the extracted layout, the user-generated-content system 106 further performs a transcription of the user-generated content using a transcription model. Additionally, the user-generated-content system 106 uses a topic-extraction model, a text-segmentation model, an entity-extraction model, and/or a relationship-extraction model to process the user-generated content according to its layout. Indeed, the user-generated-content system 106 can thus generate the genealogical record 210 by using the various models to perform various acts for transcribing user-generated content depicted in digital image 202, including transcribing the user-generated content, segmenting the transcription, determining topics from the transcription, and/or extracting entities and relationships from the transcription. Additional details regarding the user-generated-content system 106 using a genealogical-data-extracting pipeline that includes a series of specialized machine-learning models are provided below with respect to FIG. 4.

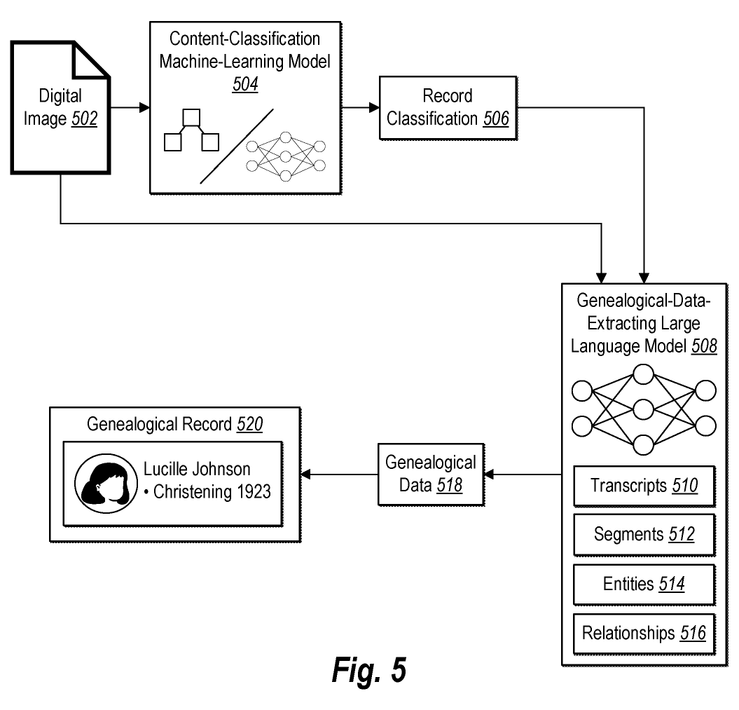

Further, in one or more embodiments, genealogical-data-extracting machine-learning model 208 is, comprises, or is configured to cooperate with a genealogical-data-extracting large language model that can extract genealogical data from a digital image 202. In particular, the user-generated-content system 106 instructs a genealogical-data-extracting large language model to generate various types of genealogical data, including transcripts, segments, entities and/or relationships, from digital image 202. In some cases, genealogical-data-extracting large language model is a third-party large language model (e.g., third-party large language model(s) 120), and the user-generated-content system 106 generates and provides a prompt instructing the third-party large language model(s) 120 to extract genealogical data from digital image 202. Additional details regarding the user-generated-content system 106 using a genealogical-data-extracting large language model to extract genealogical data from a digital image depicting user-generated content are provided below with respect to FIG. 5.

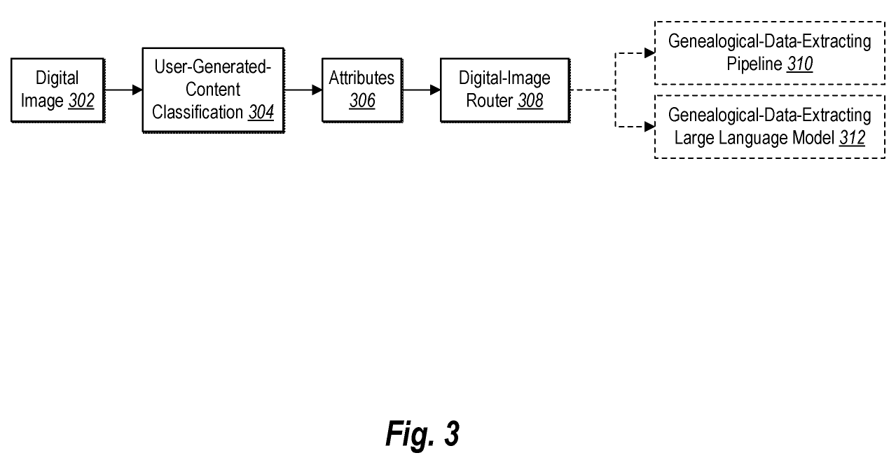

As just mentioned, the user-generated-content system 106 can utilize various types of machine-learning models to extract genealogical data from digital image 202 depicting a user-generated genealogical-content item. In one or more embodiments, the user-generated-content system 106 utilizes a digital-image router to select a machine-learning model for extracting genealogical data from digital image 202. More particularly, the user-generated-content system 106 extracts attributes from digital image 202 and, based on the attributes, selects a machine-learning model (or combination of machine-learning models) to extract genealogical data from digital image 202. Additional details regarding the user-generated-content system 106 using a digital-image router to select a machine-learning model to extract genealogical data from a digital image are provided below with respect to FIG. 3.

As previously mentioned, the user-generated-content system 106 generates genealogical record 210 from genealogical data extracted by genealogical-data-extracting machine-learning model 208. Genealogical record 210 can include, for example, a digital file that includes structured genealogical data extracted from digital image 202. Indeed, the user-generated-content system 106 can generate the genealogical record 210 as a reliable source of genealogical data by using the model pipeline described herein. For example, the user-generated-content system 106 generates genealogical record 210 by transcribing text from digital image 202 and extracting entities and relationships from the transcription. In some embodiments, the user-generated-content system 106 can extract names, dates, and/or places from digital image 202 and generate genealogical record 210 indicating the names, dates, and/or places. In some cases, prior to extracting genealogical data, the user-generated-content system 106 applies one or more image enhancement models to improve the quality of digital image 202. For instance, the system may utilize super-resolution models, de-noising models, or contrast-enhancement models to improve readability of low-resolution or compressed images uploaded by users.

In some embodiments, the user-generated-content system 106 processes digital image 202 (e.g. and generates genealogical record 210) in real time in response to a user upload event. For example, upon receiving the digital image 202 from a client device 114, the user-generated-content system 106 may immediately perform classification, layout analysis, transcription, and entity extraction without waiting for batch processing of multiple documents.

As further shown in FIG. 2, the user-generated-content system 106 utilizes genealogical record 210 to modify genealogical database 212. More specifically, the user-generated-content system 106 modifies genealogical database 212 by adding genealogical record 210 or updating an existing genealogical record (or a node with a genealogical tree) within genealogical database 212. For example, the user-generated-content system 106 can identify that an existing genealogical record matches genealogical data in genealogical record 210 and updates the existing genealogical record to reflect genealogical data in genealogical record 210. In embodiments, existing genealogical records determined by the genealogical-data system 104 to correspond to the generated genealogical record 210 may be used to supply or adjust genealogical data in the generated genealogical record 210, e.g. by detecting an error in a transcription (or an error in the original documentation) and providing an indication of the same. For example, where a user captures an image, using the client device, of a birth certificate form containing handwritten content, the genealogical-data-extracting machine-learning model 208 may generate a transcription of the handwritten content therein and generate a genealogical record 210 comprising structured data extracted from the transcription, including entities such as names, dates, and places, and relationships therebetween; where one or more such details conflict with existing genealogical data in one or more existing genealogical records in the genealogical database 212, an indication may be generated for the genealogical record 210 to indicate the detected genealogical content and the correction—based on existing genealogical records—suggested therefor.

To illustrate, for digital image 202 that depicts a marriage certificate, the user-generated-content system 106 can generate genealogical record 210 that includes a marriage date, persons associated with the marriage (e.g., bride name and groom name), and location of the marriage. If the user-generated-content system 106 identifies an existing genealogical record within genealogical database 212 that matches the information in genealogical record 210, such as a person name, the user-generated-content system 106 can update to add information from genealogical record 210, such as the date and location of the marriage. That is, in embodiments, the user-generated-content system 106 may identify a genealogical record that is determined within a threshold confidence to pertain to at least certain of the entities detected in the genealogical record 210, and to identify that the genealogical record 210 further contains additional entities and/or relationships or other details that are not present in, e.g., the genealogical database 212. The genealogical-data system 104 may modify the genealogical database 212 with the genealogical record 210 and/or with the heretofore unknown entities/relationships from the genealogical record 210.

In one or more embodiments, the user-generated-content system 106 generates confidence scores associated with extracted genealogical data. More particularly, the user-generated-content system 106 generates confidence scores based on outputs of one or more machine-learning models included within the genealogical-data-extracting machine-learning model 208, wherein the confidence scores correspond to predicted accuracies of transcribed text, detected entities, identified relationships, or other extracted genealogical information. For example, one or more models of a genealogical-data-extracting pipeline (e.g., a layout analysis model, a transcription model, or entity extraction model) may output confidence scores reflecting the likelihood that a particular transcription, entity, or relationship is correct.

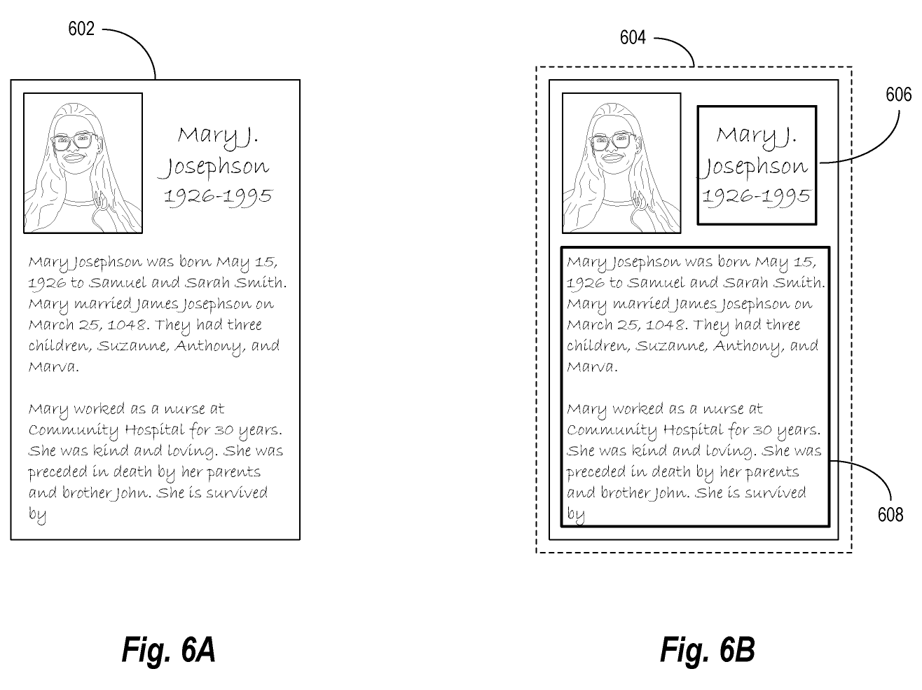

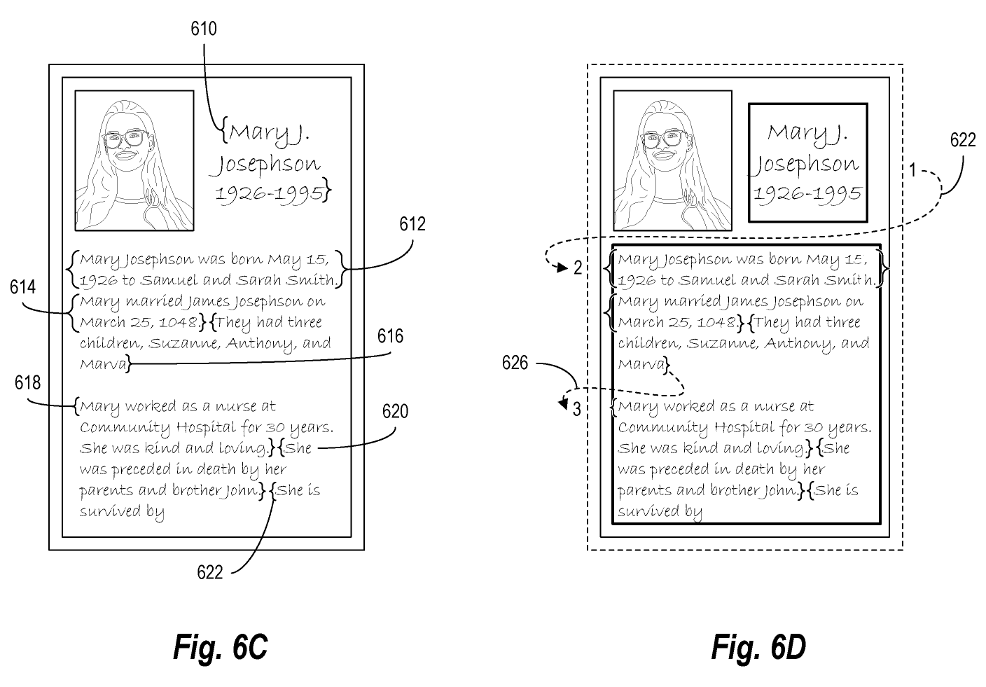

The user-generated-content system 106 can also extract layout data for user-generated genealogical-content item within a digital image 202. For instance, in some embodiments the user-generated-content system 106 utilizes a layout-extracting machine-learning model to generate layout data corresponding to a user-generated genealogical-content item depicted in digital image 202. Further, the user-generated-content system 106 utilizes the layout data when extracting genealogical data. For example, the layout-extracting machine-learning model can extract layers (or levels) of a digital image 202 to generate layout data defining boundaries between pixel regions depicting content of different labels (e.g., different formats, topics, content types, or columns). Additional details and examples of the user-generated-content system 106 using a layout-extracting machine-learning model are provided below with respect to FIGS. 6A-6D.

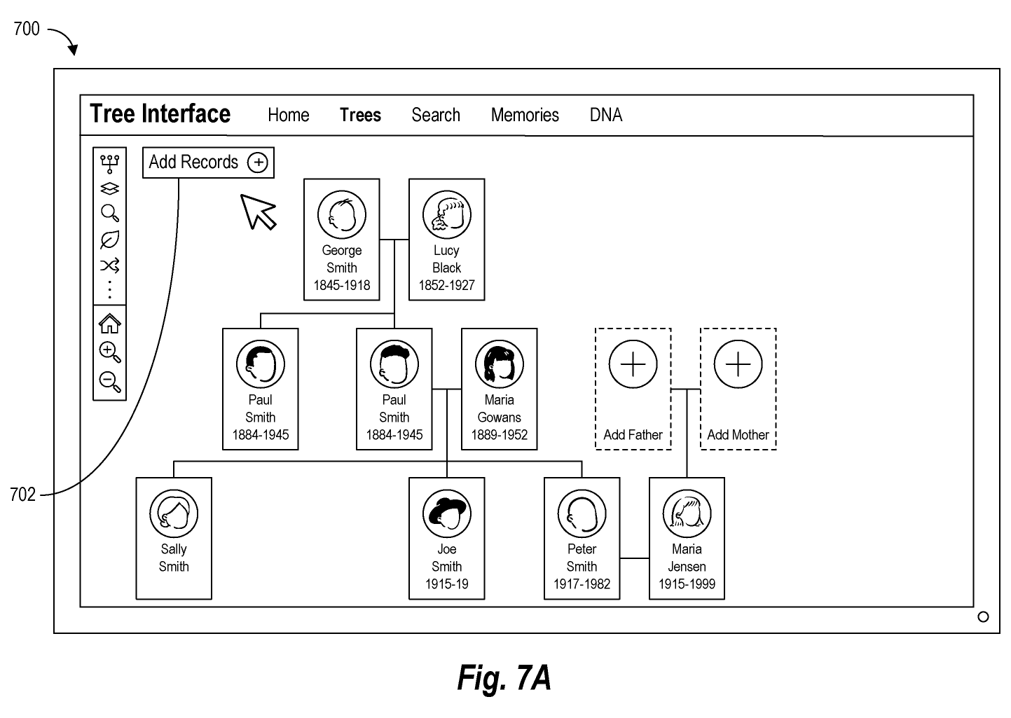

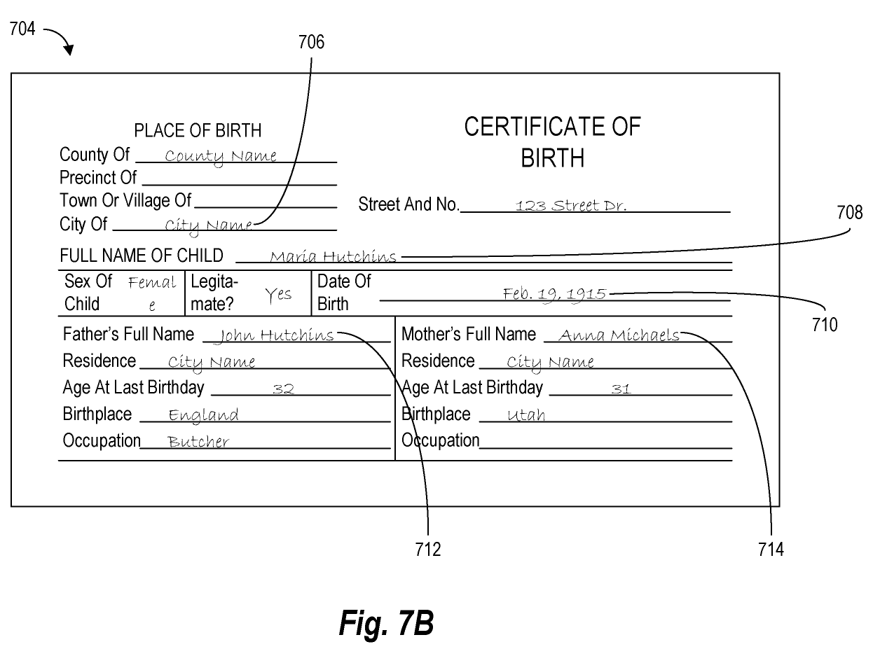

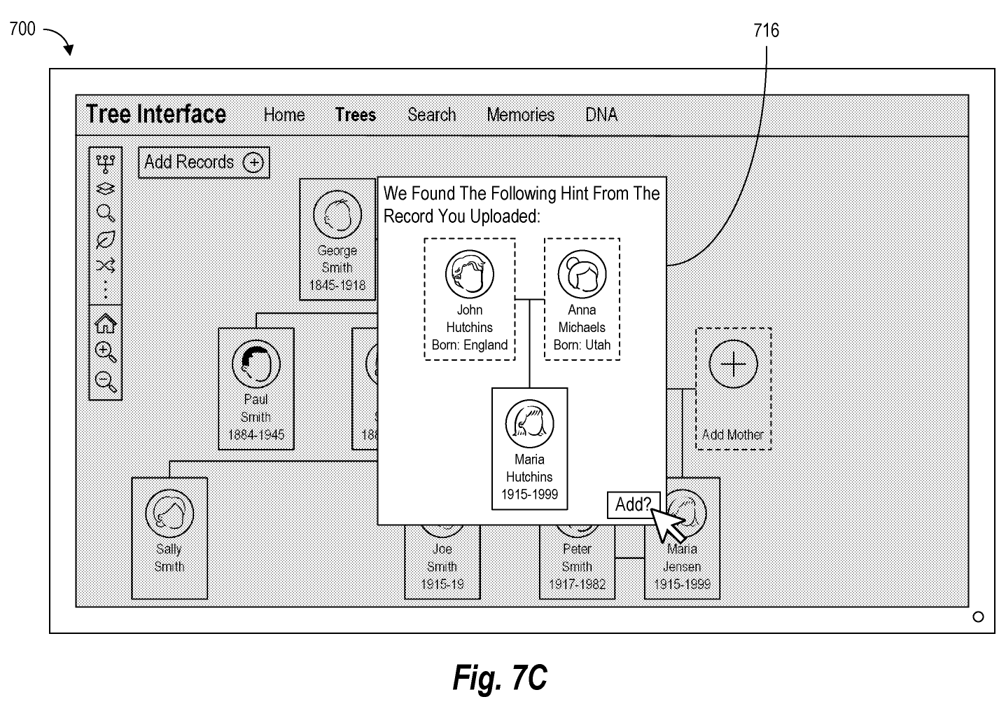

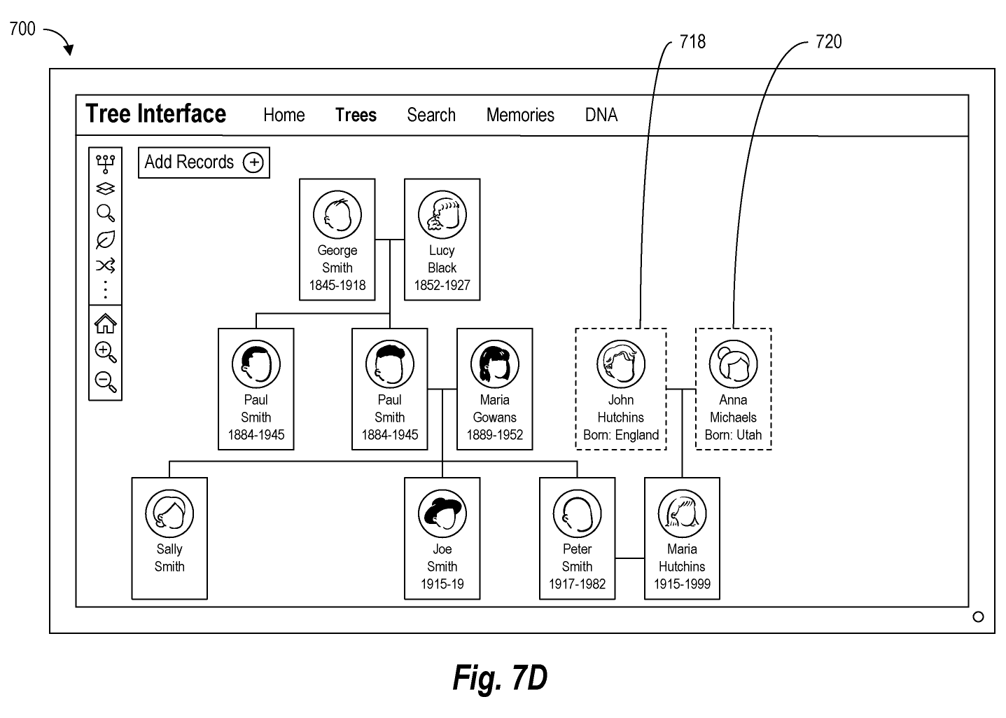

As mentioned, the user-generated-content system 106 generates genealogical record 210 using genealogical data extracted from digital image 202. In one or more embodiments, the user-generated-content system 106 provides genealogical record 210 as a suggestion to add to genealogical database 212 or a genealogical tree of the user account associated with the client device. For example, the user-generated-content system 106 can generate genealogical record 210 to indicate a connection (e.g., a tree connection) to a user account associated with the client device that added digital image 202 to genealogical-data system 104. The user-generated-content system 106 can provide genealogical record 210 within a genealogical-data interface as a suggested action to add a genealogical record (e.g., to add a new tree connection or new node for a genealogical tree) or an update to an existing genealogical record (e.g., an existing tree connection). Additional details and examples of the user-generated-content system 106 providing a genealogical hint from a digital image uploaded by a client device are provided below with respect to FIGS. 7A-7D.

As previously mentioned, the user-generated-content system 106 can utilize multiple types of machine-learning models to extract genealogical data from a digital image. In one or more embodiments, the user-generated-content system 106 utilizes a digital-image router to select a machine-learning model to use when extracting genealogical data from a digital image. FIG. 3 illustrates the user-generated-content system 106 using a digital-image router to select a machine-learning model to use when extracting genealogical data from a digital image in accordance with one or more embodiments.

As shown in FIG. 3, the user-generated-content system 106 can generate a user-generated-content classification 304 for a digital image 302. More specifically, when a client device adds the digital image 302 to the user-generated-content system 106 (or the genealogical-data system 104), the user-generated-content system 106 analyzes content depicted in the digital image 302 and generates a classification for the digital image 302 accordingly. For instance, the user-generated-content system 106 can generate the user-generated-content classification 304 based on detecting that the digital image 302 depicts user-generated content (e.g., handwritten text, hand-drawn images, hand-drawn genealogical tree, or other user-generated content) and/or content correlated to genealogical data. If the user-generated-content system 106 determines that the digital image 302 does not depict content for which the user-generated-content system 106 needs to utilize the described pipeline (or the genealogical-data-extracting large language model), the user-generated-content system 106 can generate another classification (e.g., a photograph classification). Indeed, if the user-generated-content system 106 generates a user-generated-content classification 304 for digital image 302, the user-generated-content system 106 will proceed to extract genealogical data from digital image 302 using the multi-state user-generated processing framework described herein. However, if the user-generated-content system 106 generates a classification for digital image 302 that is not user-generated-content classification 304 (e.g., a photograph classification), the user-generated-content system 106 may not utilize the described pipeline and may instead proceed with extracting genealogical data using other models and/or performing other actions (e.g., storing digital image 302). For example, family photos may be processed to detect and optionally recognize faces, such as faces of individuals confirmed to be deceased using a specialized cluster database; this advantageously allows for long-lost images to be surfaced to users with a tree node associated with a cluster to which the recognized faces are resolvable.

As further shown, the user-generated-content system 106 extracts attributes 306 from the digital image 302 and provides the attributes 306 to a digital-image router 308 (e.g., a content-classification machine-learning model and/or a function working in tandem with a content-classification machine-learning model to relay classified content to corresponding models for further processing) to select a machine-learning model to extract genealogical data from digital image 302. Specifically, digital-image router 308 analyzes the attributes 306 to select a genealogical-data-extracting pipeline 310 or a genealogical-data-extracting large language model 312 (or a combination thereof) to extract genealogical data from the digital image 302. For example, the digital-image router 308 determines that attributes 306 align with the capabilities of the genealogical-data-extracting pipeline 310, or the genealogical-data-extracting large language model 312 and selects accordingly. In some cases, the user-generated-content system 106 utilizes a graph-based routing architecture in which nodes correspond to machine-learning models and edges correspond to routing decisions. The system may dynamically route digital image 202 or intermediate outputs through different model nodes based on predicted performance characteristics.

In addition, in some embodiments, the user-generated-content system 106 can also select a combination of models based on the attributes 306. As an illustration, the user-generated-content system 106 can select a model from the genealogical-data-extracting pipeline 310 to perform a certain task, such as a transcription machine-learning model to generate a transcript and provide the output (e.g., the transcript) from the selected model to the genealogical-data-extracting large language model 312 to generate genealogical data.

In some embodiments, the user-generated-content system 106 utilizes the digital-image router 308 to route the digital image based on language for user-generated content identified in the digital image. More specifically, the user-generated-content system 106 can utilize the digital-image router 308 to route the digital image 202 to one or more specialized transcription models (e.g., of the genealogical-data-extracting pipeline 310) that are trained for particular languages. For example, a first transcription model may be trained on English handwriting samples while a second transcription model may be trained on French genealogical records. Routing based on detected language can improve transcription accuracy for multilingual user-generated content.

It has been surprisingly found that the embodiments advantageously facilitate optimized results by leveraging the best performance in particular domains from both large language model approaches (e.g. 312) and model-ensemble approaches (e.g. 310). For example, whereas the genealogical-data-extracting large language model 312 has been found to perform accurately and more efficiently with certain simple content items, where a particular instance of user-generated content contains particularly dense, complex, and/or verbose genealogical content (such as in certain arcane family-history books, for example), the purpose-built models in the model-ensemble pipeline approach provide more-accurate and less-hallucinatory results. The classifier may be trained to recognize patterns within genealogical content and to route content items to one or the other of the genealogical-data-extracting pipeline 310 or the genealogical-data-extracting large language model 312, accordingly.

In one or more embodiments, the user-generated-content system 106 determines attributes of digital image 302 when the user-generated-content system 106 determines that digital image 302 does not align with a record classification (e.g., record classification 206). Specifically, in instances where the user-generated-content system 106 does not assign a record classification for digital image 302 (e.g., the content does not align with one of BMD, journal/letter, or foreign certificate), and/or assigns a record classification of “other,” the user-generated-content system 106 will identify the attributes 306 of the digital image and select a machine-learning model based on the attributes 306. For instance, the user-generated-content system 106 can determine a certain machine-learning model will be able to extract genealogical data from digital image 302 based on attributes 306.

In some embodiments, the user-generated-content system 106 can select a machine-learning model based on language. Specifically, the user-generated-content system 106 can identify (or determine) a language for a user-generated genealogical-content item depicted within a digital image and select a machine-learning model that can extract genealogical data in the language. For example, the user-generated-content system 106 can determine that a user-generated genealogical-content item in the digital image 302 is in French and select a machine-learning model that is capable of extracting genealogical data that is in French.

In some cases, a base machine-learning model is trained across multiple languages and, even if trained for a specified task, the machine-learning model can extract data across multiple languages. For instance, machine-learning models of the genealogical-data-extracting pipeline 310 and the genealogical-data-extracting large language model 312 utilize base machine-learning models that are multilingual, therefore, the genealogical-data-extracting pipeline 310 and the genealogical-data-extracting large language model 312 can extract genealogical data from digital images across multiple languages. In other cases, the user-generated-content system 106 trains machine-learning models to generate genealogical data across multiple languages. For instance, the user-generated-content system 106 can train (or fine-tune) machine-learning models that are included in the genealogical-data-extracting pipeline 310 to generate genealogical data or genealogical records in a language that is frequently utilized across digital images depicting user-generated content, such as French. This advantageously allows the genealogical-data system 104 to facilitate review and acceptance by users across a distributed genealogical research service; for example, where a U.S. user uploads a death certificate populated and issued in a U.S. state for a French immigrant, relatives of the person of interest in France are enabled by the embodiments to more-easily access and engage with the extracted genealogical data of the user-generated content.

As previously mentioned, in one or more embodiments, the user-generated-content system 106 utilizes a series of machine-learning models to extract genealogical data from a digital image uploaded by a client device. Specifically, the user-generated-content system 106 utilizes machine-learning models that are trained to perform specific tasks and that work in series and/or in parallel to extract genealogical data from a digital image. FIG. 4 illustrates a diagram of a user-generated-content system using a genealogical-data-extracting machine-learning model that employs a series of machine-learning models to perform specific tasks in order to extract genealogical data from a digital image uploaded by a client device in accordance with one or more embodiments.

As shown, the user-generated-content system 106 utilizes a content-classification machine-learning model 404 to generate a record classification 406 for a digital image 402. In some cases, the content-classification machine-learning model 404 is trained or tuned to generate record classifications 406 for various types of digital images, such as letters/journals, certificates (e.g., birth certificates, marriage certificates, or death certificates), or foreign certificates (e.g., birth, marriage, or death certificates from foreign countries), among other possibilities.

As shown, the user-generated-content system 106 utilizes a layout-detection machine-learning model 408 to generate layout data 410 for the digital image 402. More specifically, the user-generated-content system 106 utilizes a layout-detection machine-learning model 408 to analyze pixel regions in layers (or levels) of the digital image 402 to define boundaries between pixel regions depicting content of the digital image 402. In some cases, the user-generated-content system 106 can utilize the record classification 406 in conjunction with the layout data 410 for the digital image 402. For example, the layout-detection machine-learning model 408 can include a model trained to generate the layout data 410 specifically for the record classification 406 (e.g., a model for BMD certificates, a model for letter/journals, a model for foreign certificates, etc.). Based on the record classification 406, the user-generated-content system 106 thus implements the layout-detection machine-learning model 408 to generate the layout data 410 for digital image 402. As an illustration, if the digital image 402 has a record classification of BMD certificate, then the user-generated-content system 106 selects layout-detection machine-learning model 408 (from among a set of candidate layout-extracting models) to analyze the digital image 402, where the layout-detection machine-learning model 408 is trained or tuned to generate the layout data 410 for BMD certificates.

For example, in embodiments, the layout-detection machine-learning model 408 is configured to receive, as input, a digital image and to generate bounding-box predictions therefore according in increasingly granular progressions. For instance, the layout-detection machine-learning model 408 may be configured to generate one or more bounding-box predictions for high-level segments of the digital image, such as a bounding box for a text block, a bounding box for a margin note, a bounding box for a title, or a bounding box for a signature block, etc. The bounding-box predictions may comprise coordinates and optionally a label for the type of content, in embodiments. In a subsequent level, the layout-detection machine-learning model 408 may be configured to generate more-granular bounding-box predictions within one or more of the previously generated bounding boxes. For instance, within a detected text-block bounding box, the layout-detection machine-learning model 408 may be configured to generate one or more bounding-box predictions for individual paragraphs, and then in a subsequent level to generate bounding-box predictions for individual lines within individual paragraphs.

In embodiments, the layout-detection machine-learning model 408 is configured to go back to a first level (e.g. a most-granular level) and to predict relationships between predicted bounding boxes. In embodiments, this may entail connecting an end of a paragraph that terminates on one page of a multi-page document with a beginning of a subsequent paragraph that begins on an adjacent page of the multi-page document based on a detection that the paragraphs are related spatially and/or topically. In other embodiments, this may entail detecting that margin notes pertain to an entity described in a nearby text block. Numerous possible relationships and arrangement are contemplated. The layout-detection machine-learning model 408 advantageously is configured to receive a digital image and to detect therefrom, based on the substance of content and/or spatial arrangements thereof, likely discretizations and relationships therebetween.

In some embodiments, the user-generated-content system 106 generates layout data 410 based on user selections within the digital image 402. In particular, the user-generated-content system 106 receives a user-selected region of interest associated with the digital image 202 and generates the layout data 410 corresponded to the user-selected region of interest. For example, the client device 114 may provide an interface that enables a user to specify a bounding box, polygon, or other region on the digital image 202 corresponding to a portion of the document that the user desires to analyze. The user-generated-content system 106 can utilize the region of interest as an attention constraint for one or more downstream machine-learning models, thereby prioritizing transcription, layout analysis, and entity extraction within the specified region.

In embodiments the layout-detection machine-learning model 408 is configured to predict a label based on content and/or spatial arrangement of content of a particular bounding box and to determine, based on the label, that a particular bounding box, the corresponding section of the digital image, and the genealogical content associated therewith is a separate genealogical record from adjacent content/sections/bounding boxes in the digital image, and to discretize the bounding box, image segment, and genealogical content accordingly. Thus, image segments comprising, e.g., handwritten text may be processed separately from image segments comprising, e.g., facial images, and/or from images corresponding to unrelated entities.

Indeed, in embodiments, the genealogical-data system 104 is configured to join distinct digital images as a single genealogical record based on a determination by one or more of the components described herein that the distinct digital images are, in fact, related and/or part of a same genealogical record. In embodiments, this may entail concatenating distinct digital images and processing the content thereof together and/or concatenating the content extracted and/or generated therefrom in a single downstream genealogical record, as suitable.

At least in part due to the above-described procedure of level-by-level predictions and relationship extractions, the layout-detection machine-learning model 408 advantageously reduces processing costs and latency by reducing computation overhead of keeping a plurality of images in context together simultaneously.

It has further been advantageously found that by providing a multi-stage layout-detection machine-learning model 408, with increasingly granular discretizations of and relationship predictions for content therein, the reading order by downstream transcription modalities is greatly improved. That is, whereas in existing large language models and other machine learned modalities, highly complex and/or structured input documents are liable to be processed out of the natural reading order, the above-described layout-extracting machine learning model, with progressively granular bounding-box and relationship predictions advantageously preserves the intended or original reading order, thereby preserving context for much-improved transcription speed, results, and accuracy.

As mentioned, in some cases, the user-generated-content system 106 uses a genealogical-data-extracting pipeline 412 that includes one or more specialized machine-learning models working in series and/or in parallel to extract genealogical data 424. Specifically, the user-generated-content system 106 uses genealogical-data-extracting pipeline 412 that includes machine-learning models that are each trained to perform specific tasks. The user-generated-content system 106 can select and implement models from the genealogical-data-extracting pipeline 412 according to the record classification 406 and/or based on the layout data 410. Indeed, the user-generated-content system 106 selects classification-specific models from the genealogical-data-extracting pipeline 412, such as topic-identifying machine-learning model 416, that process the user-generated content of the digital image 402 as informed by the layout data 410. Indeed, the layout data 410 can inform transcription, segmentation, and/or other processes of constituent models by indicating specific image regions of pixels for the models to process. By using machine-learning models to perform respective tasks in genealogical-data-extracting pipeline 412, the user-generated-content system 106 is able to accurately identify relationships between content within the digital image, thereby generating more accurate genealogical data for genealogical records and/or for genealogical hints.

As shown, in some embodiments, the genealogical-data-extracting pipeline 412 includes a transcription machine-learning model 414 to generate a transcription of handwritten text based on the layout data 410. In some cases, generating the transcription involves using the transcription machine-learning model 414 to generate digitized, selectable, and/or editable text through a series of stages or processes, including: grayscale conversion, noise reduction, contrast enhancement, skew correction, object detection, line and/or word segmentation, optical character recognition, and/or lexical analysis (e.g., N-gram determination and analysis). In some cases, the transcription machine-learning model 414 includes a neural network architecture (e.g., a convolutional neural network), a long short-term memory architecture, a bidirectional-encoder-representations-from-transformers (BERT) architecture, modifications and/or combinations thereof, and/or any other suitable architecture.

In one or more embodiments, the genealogical-data-extracting pipeline 412 also includes a segmentation machine-learning model 418. In particular, the segmentation machine-learning model 418 segments transcribed text generated using the transcription machine-learning model 414. For instance, the segmentation machine-learning model 418 and the transcription machine-learning model 414 can work together to generate digitized, editable, and selectable text from user-generated (e.g., handwritten) content. In some cases, the segmentation machine-learning model 418 segments text of user-generated content (in the digital image 202) using the layout data 410. In these or other cases, the segmentation machine-learning model 418 segments the user-generated content into lines, paragraphs, sentences, words, and/or characters after grayscale conversion, noise removal, and skew correction (e.g., to align the text horizontally). In particular, the segmentation machine-learning model 418 segments the user-generated content into segments that correspond to topics, entities, relationships, or otherwise as suitable.

As shown, the genealogical-data-extracting pipeline 412 further includes a topic-identifying machine-learning model 416 (or a topic-extraction model) to identify or extract topics from the user-generated content of the digital image 402, such as by using the transcription and/or the text segmentation. For example, the topic-identifying machine-learning model 416 analyzes the text according to the layout data 410 to determine topics or subjects associated with various portions of the text (e.g., different topics for different pixel regions indicated by the layout data 410). In some cases, the topic-identifying machine-learning model 416 classifies or categorizes text by topic on a layout-region-specific basis, a line-specific basis, a paragraph-specific basis, a sentence-specific, and/or a word-specific basis.

In addition, the genealogical-data-extracting pipeline 412 further includes an entity-extracting machine-learning model 420 for entity extraction (names, dates, places, etc.) and/or relationship extraction (which could be a separate model configured to receive extracted entities as input and to output relationship labels therebetween as output). In some cases, the genealogical-data-extracting pipeline 412 includes a separate model for relationship extraction while in other cases, the entity-extracting machine-learning model 420 performs both entity extraction and relationship extraction. In some embodiments, the user-generated-content system 106 performs additional post-processing of detected entities. For example, a name-parsing model may divide a detected name into components such as given name, surname, title, and suffix. A gender classification model may also infer gender attributes associated with detected person entities. In one or more embodiments, the entity-extracting machine-learning model 420 is a joint entity, relationship extraction model as described by Philip Theodore Crone et al. in U.S. Patent Application No. 17/154,316, entitled JOINT EXTRACTION OF NAMED ENTITIES AND RELATIONS FROM TEXT USING MACHINE LEARNING MODELS, filed Jan. 21, 2021, which is hereby incorporated by reference in its entirety.

Further, in one or more embodiments, the genealogical-data-extracting pipeline 412 can utilize a content-extracting machine-learning model 422 that is trained to extract structured genealogical data, such as entities (e.g., names, dates, places), from images. In some embodiments, content-extracting machine-learning model is a convolutional neural network as described in U.S. Patent No. 11,721,091 B1, entitled CLUSTERING HISTORICAL IMAGES USING A CONVOLUTIONAL NEURAL NET AND LABELED DATA BOOTSTRAPPING, filed on Jan. 26, 2021, which is hereby incorporated by reference in its entirety. Moreover, in some embodiments, a content-extracting machine-learning model is a neural network as described in U.S. Provisional Patent Application No. 63/707,615, entitled SYSTEM AND METHOD FOR EXTRACTING CONTENT FROM RECORDS, filed on Oct. 15, 2024, which is hereby incorporated by reference in its entirety.

Upon using the constituent models of the genealogical-data-extracting pipeline 412 to extract genealogical data 424, the user-generated-content system 106 utilizes the genealogical data 424 to generate a structured genealogical record 426. For example, the user-generated-content system 106 can generate the structured genealogical record 426 which the genealogical-data system 104 may associate, via a cluster database, as, for example, a new genealogical record corresponding to a new node in a genealogical tree or cluster database or as a new genealogical record corresponding to an existing genealogical record or an existing cluster.

As previously mentioned, in some embodiments, the user-generated-content system 106 utilizes a genealogical-data-extracting large language model to extract genealogical data from a digital image. Specifically, the user-generated-content system 106 instructs the genealogical-data-extracting large language model to generate genealogical data in order to identify entities, segments, transcripts, and/or relationships from a digital image. FIG. 5 illustrates a diagram of the user-generated-content system 106 using a genealogical-data-extracting large language model to extract genealogical data from a digital image in accordance with one or more embodiments.

As shown, the user-generated-content system 106 utilizes a content-classification machine-learning model 504 to generate a record classification 506 for a digital image 502. The user-generated-content system 106 then provides the record classification 506 and the digital image 502 to genealogical-data-extracting large language model 508 to generate genealogical data 518. Specifically, the user-generated-content system 106 generates a prompt for genealogical-data-extracting large language model 508 to generate the genealogical data 518 based on the record classification 506. The user-generated-content system 106 can then utilize the genealogical data 518 to generate a structured genealogical record 520 which can be used, in embodiments, to modify a genealogical database, such as a cluster database.

In one or more embodiments, the user-generated-content system 106 utilizes the genealogical-data-extracting large language model 508 to determine the genealogical data 518 by extracting respective aspects of the genealogical data 518 from the digital image 502. For example, the user-generated-content system 106 can instruct the genealogical-data-extracting large language model 508 to generate transcripts 510, segments 512 (e.g., segments of text), entities 514, and/or relationships 516 (e.g., relationships between entities) from the digital image 502. In some cases, the genealogical-data-extracting large language model 508 is a third-party large language model located on a third-party server and the user-generated-content system 106 includes instructions for generating the genealogical data 518 in a prompt (or multiple prompts) to the third-party large language model. In other cases, the genealogical-data-extracting large language model 508 is local to the user-generated-content system 106 and is fine-tuned to generate the genealogical data 518 from digital images uploaded by client devices and a prompt does not include details on how to generate the genealogical data 518. For example, the genealogical-data-extracting large language model 508 may be a visual large language model fine-tuned using labeled images comprising, e.g., labeled obituaries, journal pages, letters, family-history book pages, and other images pertinent to user-generated content. It will further be appreciated that while large language models are described, the disclosure is not limited thereto; rather, the embodiments may be configured to utilize or cooperate with any suitable artificial-intelligence modality for generating structured genealogical records from user-generated content records.

In one or more embodiments, the user-generated-content system 106 can utilize additional machine-learning models to extract information or data from digital image and provide the information to genealogical-data-extracting large language model 508. For example, the user-generated-content system 106 can utilize a layout-extracting machine-learning model (e.g., layout-detection machine-learning model 408 and/or a large language model) to generate layout data for digital image 502 and provide the layout data to the genealogical-data-extracting large language model 508 (e.g., in a prompt). As another example, the user-generated-content system 106 can utilize models from the genealogical-data-extracting pipeline 412 and provide the output to genealogical-data-extracting large language model 508. For example, the user-generated-content system 106 can utilize an entity-extracting machine-learning model to extract entities 514 from the digital image 502 and instruct the genealogical-data-extracting large language model 508 to generate the genealogical data 518 based on the entities 514.

As previously mentioned, the user-generated-content system 106 utilizes a layout-extracting machine-learning model to generate layout data for a digital image. In particular, the user-generated-content system 106 uses a layout-extracting machine-learning model to identify a layout by extracting layers of a digital image. FIGS. 6A-6D illustrate the user-generated-content system 106 using a layout-extracting machine-learning model to generate layout data in accordance with one or more embodiments.

In one or more embodiments, the user-generated-content system 106 utilizes a layout-extracting machine-learning model to extract layout data by generating layers for a digital image. As shown in FIG. 6A, the user-generated-content system 106 provides digital image 602 as an input to layout-extracting machine-learning model.

As shown in FIG. 6B the user-generated-content system 106 uses the layout-extracting machine-learning model to extract a first layer (or level) of the digital image 602 (depicting user-generated content in the form of handwritten text) by extracting or generating bounding boxes for the text. For example, the user-generated-content system 106 identifies bounding box 604 as a boundary around all text in digital image 602, including the margin note and image. The user-generated-content system 106 also identifies bounding box 606 that indicates a title in the digital image and bounding box 608 that indicates a paragraph of text in digital image 602.

Further, as shown in FIG. 6C, the user-generated-content system 106, using the layout-extracting machine-learning model, then segments the block of text within bounding box 604 into individual lines of text, such as lines of a paragraph. For example, the user-generated-content system 106 can identify text segment 610, text segment 612, text segment 614, text segment 616, text segment 618, text segment 620 and text segment 622 as individual segments of text within paragraphs of text within digital image 602.

Moreover, as shown in FIG. 6D, the user-generated-content system 106, using the layout-extracting machine-learning model, then extracts relationships between the text blocks to identify the layout of the digital image 602. For example, the user-generated-content system 106 identifies a layout through a text flow 624 that indicates that the text flows from a first block of text to a second block of text, a text flow 626 that indicates that the text flows from a second block of text to a third block of text.

As previously mentioned, the user-generated-content system 106 generates a genealogical record from a digital image. In one or more embodiments, the user-generated-content system 106 utilizes the genealogical record to modify a genealogical tree of a user account. FIGS. 7A-7D illustrate example graphical user interfaces of the user-generated-content system 106 modifying genealogical trees using genealogical data extracted from user-generated genealogical-content items in accordance with one or more embodiments.

As shown in FIG. 7A, the user-generated-content system 106 provides an option 702 within genealogical interface 700 for a client device to add digital images to a genealogical-data system 104. In some cases, the user-generated-content system 106 generates digital images from user-generated genealogical-content item added by client devices. For example, if a client device uploads a PDF of birth certificate, the user-generated-content system 106 generates a digital image of the PDF that depicts the birth certificate as in the PDF.

As further shown in FIG. 7B, and as previously described, the user-generated-content system 106 can extract genealogical data from digital image 704 (depicting user-generated content on a birth certificate). After using the machine-learning models previously described (e.g., the genealogical-data-extracting machine-learning model, the content-extracting machine-learning model, the genealogical-data-extracting machine-learning model, and other related machine-learning models), the user-generated-content system 106 generates genealogical data. In particular, the user-generated-content system 106 generates the genealogical data by identifying entities within digital image 704. For example, as shown, for the digital image 704 that is a birth certificate, the user-generated-content system 106 can extract birth city 706, given name 708, birth date 710, parent name 712, and parent name 714.

As shown in FIG. 7C, in some embodiments the user-generated-content system 106 provides a genealogical hint that corresponds to a genealogical record generated using genealogical data extracted from digital image 704. For example, the user-generated-content system 106 can provide a genealogical hint by providing node suggestion 716 to add to a genealogical tree of a user account associated with the client device. In some instances, node suggestion 716 is a suggestion for a new node to add to the genealogical tree based on a detected relationship between entities, including an entity already represented by a node within the genealogical tree and an entity not yet represented by a node within the genealogical tree but which should, based on the detected relationship, be added to the genealogical tree. In other instances, node suggestion 716 is a suggestion for an update to an existing node of the genealogical tree, such as an update to data associated therewith, such as a more-accurate birth date.

As shown in FIG. 7D, based on a user interaction with node suggestion 716, the user-generated-content system 106 adds node 718 and node 720 to a genealogical tree within genealogical interface 700. In some cases, where the user-generated-content system 106 updates an existing node in a genealogical tree, the user-generated-content system 106 will update a node within genealogical interface 700 with genealogical data extracted from a digital image added by a client device. Indeed, unlike existing systems that allow users to upload images of user-generated content but do not use it to generate (or update) genealogical records, the user-generated-content system 106 accurately extracts genealogical data from digital images depicting user-generated genealogical-content item and can update a genealogical database by generating (or updating) genealogical records and genealogical trees.

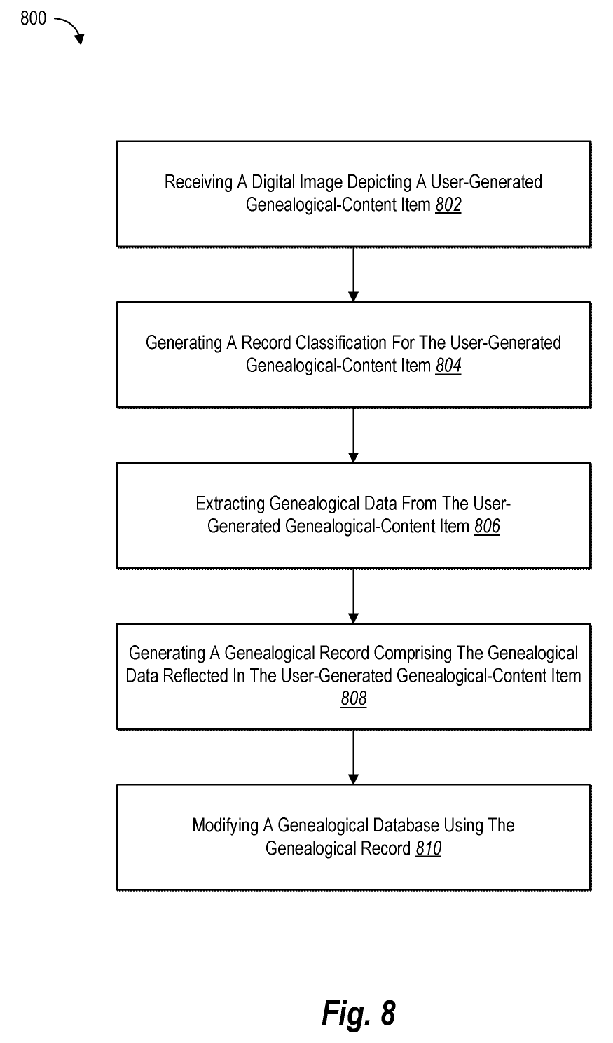

FIGS. 1-7D, the corresponding text, and the examples provide a number of different methods, systems, devices, and non-transitory computer-readable media of the genealogical-data system 104. In addition to the foregoing, one or more embodiments can also be described in terms of flowcharts comprising acts for accomplishing a particular result, as shown in FIG. 8. FIG. 8 may be performed with more or fewer acts. Further, the acts may be performed in differing orders. Additionally, the acts described herein may be repeated or performed in parallel with one another or parallel with different instances of the same or similar acts.

As mentioned, FIG. 8 illustrates a flowchart of a series of acts 800 for using various machine-learning models to extract genealogical data from user-generated genealogical-content items and generating genealogical records comprising the genealogical data in accordance with one or more embodiments. While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer-readable medium can comprise instructions that, when executed by one or more processors, cause a computing device to perform the acts of FIG. 8. In some embodiments, a system can perform the acts of FIG. 8.

As shown in FIG. 8, the series of acts 800 includes an act 802 of receiving an image depicting a user-generated genealogical-content item, an act 804 of generating a record classification for the user-generated, an act 806 of extracting genealogical data from the user-generated genealogical-content item, an act 808 of generating a genealogical record comprising the genealogical data reflected in the user-generated genealogical-content item, and an act 810 of modifying a genealogical database using the genealogical record.

In particular, the act 802 can include receiving a digital image depicting a user-generated genealogical-content item from a client device associated with a genealogical-data system, the act 804 can include generating, using a content-classification machine-learning model to process the digital image, a record classification for the user-generated genealogical-content item, the act 806 can include extracting, using a genealogical-data-extracting machine-learning pipeline, genealogical data from the user-generated genealogical-content item based on the record classification for the user-generated genealogical-content item, the act 808 can include generating, from the genealogical data, a genealogical record comprising the genealogical data reflected in the user-generated genealogical-content item, and the act 810 can include modifying a genealogical database using the genealogical record.

For example, the series of acts 800 can include acts to perform any of the operations described in the following clauses:

CLAUSE 1. A computer-implemented method comprising receiving a digital image depicting a user-generated genealogical-content item from a client device associated with a genealogical-data system, generating, using a content-classification machine-learning model to process the digital image, a record classification for the user-generated genealogical-content item, extracting, using a genealogical-data-extracting machine-learning pipeline, genealogical data from the user-generated genealogical-content item based on the record classification for the user-generated genealogical-content item, generating, from the genealogical data, a genealogical record comprising the genealogical data reflected in the user-generated genealogical-content item, and modifying a genealogical database using the genealogical record.

CLAUSE 2. The computer-implemented method of clause 1, wherein extracting the genealogical data from the user-generated genealogical-content item further comprises generating, using a layout-detection machine-learning model, layout data for the user-generated genealogical-content item, and extracting, using the genealogical-data-extracting machine-learning pipeline, the genealogical data from the user-generated genealogical-content item based on the layout data.

CLAUSE 3. The computer-implemented method of any of clauses 1-2, wherein generating the layout data further comprises generating, using the layout-detection machine-learning model, a first plurality of bounding box predictions for a first level of the user-generated genealogical-content item, generating, using the layout-detection machine-learning model, a second plurality of bounding box predictions for a second level of the user-generated genealogical-content item, and generating the layout data for the user-generated genealogical-content item based on predicted relationships between the first plurality of bounding box predictions and the second plurality of bounding box predictions.

CLAUSE 4. The computer-implemented method of any of clauses 1-3, wherein generating the record classification further comprises generating, using the content-classification machine-learning model of the genealogical-data-extracting machine-learning pipeline, predicted region boundaries indicating sections of handwritten content in the user-generated genealogical-content item, and generating, using the content-classification machine-learning model, the record classification for the user-generated genealogical-content item based on the predicted region boundaries corresponding to region boundaries for a predetermined record classification.

CLAUSE 5. The computer-implemented method of any of clauses 1-4, further comprising extracting the genealogical data by generating, using a transcription machine-learning model of the genealogical-data-extracting machine-learning pipeline, a transcription of handwritten text in the user-generated genealogical-content item, and generating the genealogical record comprising at least a portion of the transcription of the handwritten text in the user-generated genealogical-content item.

CLAUSE 6. The computer-implemented method of any of clauses 1-5, further comprising extracting the genealogical data by generating, using a segmentation machine-learning model of the genealogical-data-extracting machine-learning pipeline, one or more segments for the user-generated genealogical-content item, and generating the genealogical record based on the one or more segments for the user-generated genealogical-content item.

CLAUSE 7. The computer-implemented method of any of clauses 1-6, further comprising extracting the genealogical data by generating, using a topic-identifying machine-learning model of the genealogical-data-extracting machine-learning pipeline, a topic for the user-generated genealogical-content item, and generating the genealogical record based on the topic for the user-generated genealogical-content item.

CLAUSE 8. The computer-implemented method of any of clauses 1-7, further comprising extracting the genealogical data by extracting, using an entity-extracting machine-learning model of the genealogical-data-extracting machine-learning pipeline, one or more entities reflected in the user-generated genealogical-content item, and generating the genealogical record comprising the one or more entities reflected in the user-generated genealogical-content item.

CLAUSE 9. The computer-implemented method of any of clauses 1-8, further comprising extracting the genealogical data by extracting, using a content-extracting machine-learning model of the genealogical-data-extracting machine-learning pipeline, structured genealogical data reflected in the user-generated genealogical-content item, and generating the genealogical record comprising the structured genealogical data reflected in the user-generated genealogical-content item.

CLAUSE 10. A non-transitory computer-readable medium storing instructions that, when executed by at least one processor, cause a computer system to receive a digital image depicting a user-generated genealogical-content item from a client device associated with a genealogical-data system, generate, using a content-classification machine-learning model to process the digital image, a record classification for the user-generated genealogical-content item, extract, using a genealogical-data-extracting large language model, genealogical data from the user-generated genealogical-content item based on the record classification for the user-generated genealogical-content item, generate, from the genealogical data, a genealogical record comprising the genealogical data reflected in the user-generated genealogical-content item, and modify a genealogical database using the genealogical record.

CLAUSE 11. The non-transitory computer-readable medium of clause 10, further comprising instructions that, when executed by the at least one processor, cause the computer system to generate, using a layout-detection machine-learning model, layout data for the user-generated genealogical-content item, and extracting, using the genealogical-data-extracting large language model, the genealogical data from the user-generated genealogical-content item based on the layout data.

CLAUSE 12. The non-transitory computer-readable medium of any of clauses 10-11, further comprising instructions that, when executed by the at least one processor, cause the computer system to generate the record classification by generating, using the content-classification machine-learning model, predicted region boundaries indicating sections of handwritten content in the user-generated genealogical-content item, and generating, using the content-classification machine-learning model, the record classification for the user-generated genealogical-content item based on the predicted region boundaries corresponding to region boundaries for a predetermined record classification.

CLAUSE 13. The non-transitory computer-readable medium of any of clauses 10-12, further comprising instructions that, when executed by the at least one processor, cause the computer system to extract the genealogical data by generating, using the genealogical-data-extracting large language model, a transcript of handwritten text reflected in the user-generated genealogical-content item, and generating the genealogical record comprising at least a portion of the transcript of the handwritten text reflected in the user-generated genealogical-content item.

CLAUSE 14. The non-transitory computer-readable medium of any of clauses 10-13, further comprising instructions that, when executed by the at least one processor, cause the computer system to extract the genealogical data by extracting, using the genealogical-data-extracting large language model, one or more entities reflected in the user-generated genealogical-content item, and generate the genealogical record comprising the one or more entities reflected in the user-generated genealogical-content item.

CLAUSE 15. The non-transitory computer-readable medium of any of clauses 10-14, further comprising instructions that, when executed by the at least one processor, cause the computer system to extract the genealogical data by determining, using the genealogical-data-extracting large language model, one or more relationships reflected in the user-generated genealogical-content item, and generate the genealogical record comprising the one or more relationships reflected in the user-generated genealogical-content item.

CLAUSE 16. A system comprising at least one processor, and at least one non-transitory computer-readable storage medium storing instructions that, when executed by the at least one processor, cause the system to receive a digital image depicting a user-generated genealogical-content item from a client device associated with a genealogical-data system, generate, using a content-classification machine-learning model to process the digital image, a record classification for the user-generated genealogical-content item, extract, using a genealogical-data-extracting machine-learning model specific to the record classification, genealogical data from the user-generated genealogical-content item based on layout data for the user-generated genealogical-content item, generate, from the genealogical data, a genealogical record comprising the genealogical data reflected in the user-generated genealogical-content item, and modify a genealogical database using the genealogical record.

CLAUSE 17. The system of clause 16, further comprising instructions that, when executed by the at least one processor, cause the system to generate the genealogical-data-extracting machine-learning model specific to the record classification by training a machine-learning model using digital images comprising user-generated genealogical-content items corresponding to the record classification.

CLAUSE 18. The system of any of clauses 16-17, further comprising instructions that, when executed by the at least one processor, cause the system to extract the genealogical data from the user-generated genealogical-content item based on the layout data for the user-generated genealogical-content item by generating the layout data based on using a layout-detection machine-learning model to generate bounding box predictions for the user-generated genealogical-content item, and extracting the genealogical data from the user-generated genealogical-content item based on the bounding box predictions.

CLAUSE 19. The system of any of clauses 16-18, further comprising instructions that, when executed by the at least one processor, cause the system to extract the genealogical data by extracting, using an entity-extracting machine-learning model, one or more entities reflected in the user-generated genealogical-content item, and generate the genealogical record comprising the one or more entities reflected in the user-generated genealogical-content item.

CLAUSE 20. The system of any of clauses 16-19, further comprising instructions that, when executed by the at least one processor, cause the system to extract the genealogical data by extracting, using a content-extracting machine-learning model, structured genealogical data reflected in the user-generated genealogical-content item, and generate the genealogical record comprising the structured genealogical data reflected in the user-generated genealogical-content item.

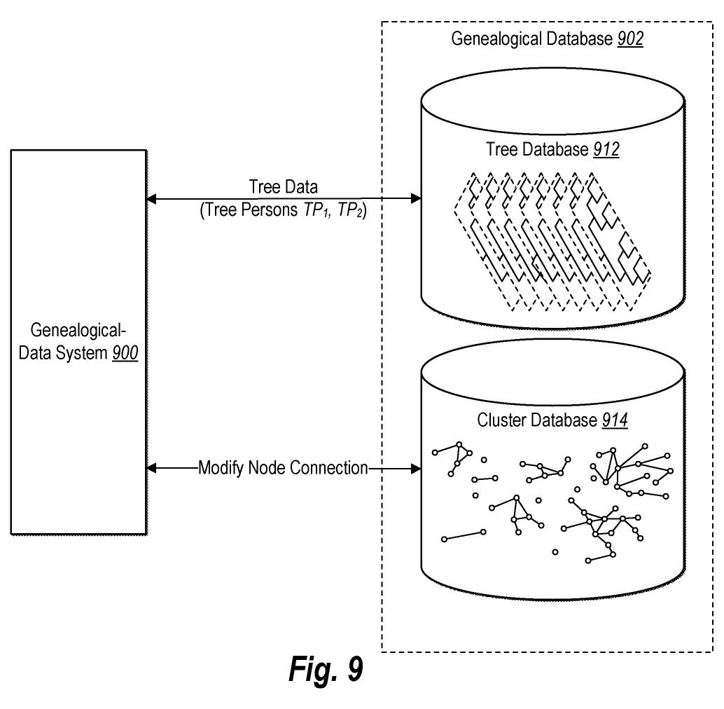

FIG. 9 illustrates a genealogical-data system 900 (e.g., the genealogical-data system 104) interfacing with a genealogical database 902 in accordance with one or more embodiments. For certain genealogical databases, the genealogical-data system 900 identifies groups of user nodes or records in the format of a genealogical tree or records connected by biological and other family relationships as “tree data.” The genealogical-data system 900 can thus search and process tree data stored in a genealogical database 902 (which includes a tree database 912 and a cluster database 914) to execute tasks and perform functions as described herein.

In one or more embodiments, the genealogical-data system 900 can resolve duplicate entities corresponding to respective genealogical records. Indeed, the genealogical-data system 900 can determine that two entities or individuals in a cluster database are the same individual, despite differences in various data, such as name spelling, discrepancies in certain dates, and/or other variances in data. The genealogical-data system 900 can analyze clusters of genealogical records stored for each individual within the cluster database 914 to determine that the clusters are within a threshold similarity of one another and that, therefore, the clusters should be combined or otherwise resolved to represent a single individual. In some cases, the genealogical-data system 900 can compare clusters by extracting vectors from the genealogical records in the clusters, averaging the vectors to generate cluster vectors (or otherwise determining weighted or unweighted cluster centers) representative of respective clusters, and determining distances (e.g., Euclidean or cosine distances) between the cluster vectors. The genealogical-data system 900 can further propagate such entity resolution to the tree database 912 to update nodes (e.g., representing tree persons such as TP₁ or TP₂) and edges within a universal genealogical tree, resolving two previously disparate nodes into a single node as indicated by the newly resolved (or combined clusters in the cluster database 914.

For the genealogical database 902, the genealogical-data system 900 may receive genealogical data (e.g., data records and/or genealogical data objects) for building tree data from a source selected from a ground-truth genealogical tree generated from genealogical records and trees of user accounts within the genealogical-data system 900, from the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, and a motor vehicle database. Additionally, genealogical data can be user-generated-content, as described above. Genealogical data may also include data from a cluster database 914 derived from records and user data.

Some embodiments of the user-generated-content system 106 relate to modifying a cluster database 914 based on a user query and/or other interaction with the user-generated-content system 106. In some instances, the genealogical-data system 900 (or the user-generated-content system 106) determines and/or modifies a node connection for an individual represented by or resolved to a cluster within the cluster database 914. Indeed, the user-generated-content system 106 can analyze, add, remove, and/or modify genealogical content items organized into clusters within the cluster database 914 based on relatedness corresponding to a common individual. The user-generated-content system 106 can also access, modify, and analyze genealogical trees within the tree database 912 by, for example, adding nodes, removing nodes, and/or modifying nodes based genealogical content items (and their relationships to individuals) stored within the cluster database 914.

As seen in FIG. 9, the genealogical-data system 900 includes a genealogical database 902, which may include a tree database 912 and a cluster database 914. The tree database 912 may be configured to facilitate the generation, storage, and collation of family trees for a plurality of users, with trees comprising nodes and edges therebetween. Data and records, such as images, may be associated with individual nodes of the trees in the tree database 912. Tree person data, including data such as names, relationships, dates, events, and other metadata may be provided by the tree database 912 to the genealogical-data system 900. The cluster database 914 may include one or more clusters comprising resolved entities, where tree persons (nodes) in different trees in the tree database 912 are associated together in a cluster after determination that the tree persons correspond to a same person.

As a user expands their family tree, e.g. by tagging a previously unknown person in an image using the suggestions provided by the ancestor-identification system and adding the now-identified person to their tree as a new node, the tree database 912 may be modified as the user’s family tree is expanded, and the cluster database 914 may be modified to include the new node in the pertinent cluster. Further, the user-generated-content system 106 can attach a conversation with a user account (e.g., a query received from the user account and a response the user-generated-content system 106 generates, and/or a series of queries and corresponding responses) to a cluster within the cluster database 914 and/or a node within the tree database 912 to utilize as a ground-truth genealogical tree for future operations within the genealogical-data system 900. For example, the user-generated-content system 106 can extract or otherwise pull contextual data from the user account or conversations with the user account (e.g., such as digital image 402 in FIG. 4 or digital image 502 in FIG. 5) and attach the context to a node or a cluster of the cluster database 914 to utilize as a ground-truth genealogical tree for future operations within the genealogical-data system 900 and/or the user-generated-content system 106.

FIG. 10 is a block diagram of an architecture of an example computing server 1000 (e.g., the server device(s) 102), in accordance with some embodiments. In the embodiment shown in FIG. 10, the computing server 1000 includes a genealogy data store 1002, a genetic data store 1004, an individual profile store 1006, a sample pre-processing engine 1008, a phasing engine 1010, an identity by descent (IBD) estimation engine 1012, a community assignment engine 1014, an IBD network data store 1016, a reference panel sample store 1018, an ethnicity estimation engine 1020, a front-end interface 1022, and a tree management engine 1024. The functions of the computing server 1000 may be distributed among the elements in a different manner than described. In various embodiments, the computing server 1000 may include different components and fewer or additional components. Each of the various data stores may be a single storage device, a server controlling multiple storage devices, or a distributed network that is accessible through multiple nodes (e.g., a cloud storage system).

The computing server 1000 stores various data of different individuals, including genetic data, genealogy data, and survey response data. The computing server 1000 processes the genetic data of individuals (e.g., genetic profiles) to identify shared identity-by-descent (IBD) segments between individuals. The genealogy data and survey response data may be part of user account profile data. The amount and type of user account profile data stored for each individual may vary based on the information of an individual, which determined or received from the individual through creating an account and profile at a system (e.g., the genealogical-data system 104) operated by the computing server 1000, and through updating the profile, family tree, and social network at the system, in some cases linking a profile with genetic data. The computing server 1000 may also include answers to survey questions regarding various traits of individuals, such as phenotypes, characteristics, preferences, habits, lifestyle, and environment for user accounts.

The genealogy data store 1002 may store genealogy data, including various types of data that are related to tracing family relatives of individuals. Examples of genealogy data include names (first, last, middle, suffixes), gender, birth locations, date of birth, date of death, marriage information, spouse's information kinships, family history, dates and places for life events (e.g., birth and death), other vital data, and the like. In some instances, family history can take the form of a pedigree of an individual (e.g., the recorded relationships in the family). The family tree information associated with an individual may include one or more specified nodes. Each node in the family tree represents the individual, an ancestor of the individual who might have passed down genetic material to the individual, and the individual's other relatives including siblings, cousins, and offspring in some cases. Genealogy data may also include connections and relationships among user accounts of the computing server 1000.

In addition to user account data, genealogy data may also take other forms that are obtained from various sources such as public records and third-party data collectors. For example, genealogical records from public sources include birth records, marriage records, death records, census records, court records, probate records, adoption records, and/or obituary records. Likewise, genealogy data may include data from one or more family trees of an individual, the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, and/or a motor vehicle database.

Furthermore, the genealogy data store 1002 may also include relationship information inferred from the genetic data stored in the genetic data store 1004 and information received from the individuals. For example, the relationship information may indicate which individuals are genetically related, how they are related, how many generations back they share common ancestors, lengths and locations of IBD segments shared, which genetic communities an individual is a part of, variants carried by the individual, and the like.

The computing server 1000 maintains genetic datasets of individuals in the genetic data store 1004. A genetic dataset of an individual may be a digital dataset of nucleotide data (e.g., SNP data) and corresponding metadata. A genetic dataset may contain data on the whole or portions of an individual's genome. The genetic data store 1004 may store a pointer to a location associated with the genealogy data store 1002 associated with the individual. A genetic dataset may take different forms. In some embodiments, a genetic dataset may take the form of a base pair sequence of the sequencing result of an individual. A base pair sequence dataset may include the whole genome of the individual (e.g., obtained from a whole-genome sequencing) or some parts of the genome (e.g., genetic loci of interest).

In another embodiment, a genetic dataset may take the form of sequences of genetic markers. Examples of genetic markers may include target SNP loci (e.g., allele sites) filtered from the sequencing results. A SNP locus that is single base pair long may also be referred to a SNP site. A SNP locus may be associated with a unique identifier. The genetic dataset may be in a form of diploid data that includes a sequencing of genotypes, such as genotypes at the target SNP loci, or the whole base pair sequence that includes genotypes at known SNP loci and other base pair sites that are not commonly associated with known SNPs. The diploid dataset may be referred to as a genotype dataset or a genotype sequence. Genotype may have a different meaning in various contexts. In one context, an individual's genotype may refer to a collection of diploid alleles of an individual. In other contexts, a genotype may be a pair of alleles present on two chromosomes for an individual at a given genetic marker such as a SNP site.

Genotype data for a SNP site may include a pair of alleles. The pair of alleles may be homozygous (e.g., A-A or G-G) or heterozygous (e.g., A-T, C-T). Instead of storing the actual nucleotides, the genetic data store 1004 may store genetic data that are converted to bits. For a given SNP site, oftentimes only two nucleotide alleles (instead of all 4) are observed. As such, a 2-bit number may represent a SNP site. For example, 00 may represent homozygous first alleles, 11 may represent homozygous second alleles, and 01 or 10 may represent heterozygous alleles. A separate library may store what nucleotide corresponds to the first allele and what nucleotide corresponds to the second allele at a given SNP site.

A diploid dataset may also be phased into two sets of haploid data, one corresponding to a first parent side and another corresponding to a second parent side. The phased datasets may be referred to as haplotype datasets or haplotype sequences. Similar to genotype, haplotype may have a different meaning in various contexts. In one context, a haplotype may also refer to a collection of alleles that corresponds to a genetic segment. In other contexts, a haplotype may refer to a specific allele at a SNP site. For example, a sequence of haplotypes may refer to a sequence of alleles of an individual that are inherited from a parent.

The individual profile store 1006 stores profiles and related metadata associated with various individuals appeared in the computing server 1000. A computing server 1000 may use unique individual identifiers to identify various user accounts and other non-user accounts that might appear in other data sources such as ancestors or historical persons who appear in any family tree or genealogy database. A unique individual identifier may be a hash of certain identification information of an individual, such as a user account's account name, user account's name, date of birth, location of birth, or any suitable combination of the information. The profile data related to an individual may be stored as metadata associated with an individual's profile. For example, the unique individual identifier and the metadata may be stored as a key-value pair using the unique individual identifier as a key.

An individual's profile data may include various kinds of information related to the individual. The metadata about the individual may include one or more pointers associating genetic datasets such as genotype and phased haplotype data of the individual that are saved in the genetic data store 1004. The metadata about the individual may also be individual information related to family trees and pedigree datasets that include the individual. The profile data may further include declarative information about the user account that was authorized by the user account to be shared and may also include information inferred by the computing server 1000. Other examples of information stored in a user account profile may include biographic, demographic, and other types of descriptive information such as work experience, educational history, gender, hobbies, or preferences, and/or location. In some embodiments, the user account profile data may also include one or more photos of the user accounts and photos of relatives (e.g., ancestors) of the user accounts that are uploaded by the user accounts. A user account may authorize the computing server 1000 to analyze one or more photos to extract information, such as the user account's or relative's appearance traits (e.g., blue eyes, curved hair, etc.), from the photos. The appearance traits and other information extracted from the photos may also be saved in the profile store. In some cases, the computing server may allow user accounts to upload many different photos of the user accounts, their relatives, and even friends. User account profile data may also be obtained from other suitable sources, including historical records (e.g., records related to an ancestor), medical records, military records, photographs, other records indicating one or more traits, and other recorded data.

For example, the computing server 1000 may present various survey questions to its user accounts from time to time. The responses to the survey questions may be stored at individual profile store 1006. The survey questions may be related to various aspects of the user accounts and the user account families. Some survey questions may be related to user account phenotypes, while other questions may be related to environmental factors of the user accounts.

Survey questions may concern health or disease-related phenotypes, such as questions related to the presence or absence of genetic diseases or disorders, inheritable diseases or disorders, or other common diseases or disorders that have a family history as one of the risk factors, questions regarding any diagnosis of increased risk of any diseases or disorders, and questions concerning wellness-related issues such as a family history of obesity, and/or family history of causes of death. The diseases identified by the survey questions may be related to single-gene diseases or disorders that are caused by a single-nucleotide variant, an insertion, or a deletion. The diseases identified by the survey questions may also be multifactorial inheritance disorders that may be caused by a combination of environmental factors and genes. Examples of multifactorial inheritance disorders may include heart disease, Alzheimer's disease, diabetes, cancer, and obesity. The computing server 1000 may obtain data on a user account's disease-related phenotypes from survey questions about the health history of the user account and her family and also from health records uploaded by the user account.

Survey questions also may be related to other types of phenotypes such as appearance traits of the user accounts. A survey regarding appearance traits and characteristics may include questions related to eye color, iris pattern, freckles, chin types, finger length, dimple chin, earlobe types, hair color, hair curl, skin pigmentation, susceptibility to skin bum, bitter taste, male baldness, baldness pattern, presence of unibrow, presence of wisdom teeth, height, and weight. A survey regarding other traits also may include questions related to user account taste and smell such as the ability to taste bitterness, asparagus smell, and/or cilantro aversion. A survey regarding traits may further include questions related to user account body conditions such as lactose tolerance, caffeine consumption, malaria resistance, norovirus resistance, muscle performance, alcohol flush, etc. Other survey questions regarding a person's physiological or psychological traits may include vitamin traits and sensory traits such as the ability to sense an asparagus metabolite. Traits may also be collected from historical records, electronic health records and electronic medical records.

The computing server 1000 also may present various survey questions related to the environmental factors of user accounts. In this context, an environmental factor may be a factor that is not directly connected to the genetics of user accounts. Environmental factors may include user account preferences, habits, and lifestyles. For example, a survey regarding user account preferences may include questions related to things and activities that user accounts like or dislike, such as types of music a user account enjoys, dancing preference, party-going preference, certain sports that a user account plays, video game preferences, etc. Other questions may be related to diet preferences such as liking or disliking a certain type of food (e.g., ice cream, egg). A survey related to habits and lifestyle may include questions regarding smoking habits, alcohol consumption and frequency, daily exercise duration, sleeping habits (e.g., morning person versus night person), sleeping cycles and problems, hobbies, and travel preferences. Additional environmental factors may include diet amount (calories, macronutrients), physical fitness abilities (e.g., stretching, flexibility, heart rate recovery), family type (adopted family or not, has siblings or not, lived with extended family during childhood), property and item ownership (has home or rents, has a smartphone or does not, has a car or does not).

Surveys also may be related to other environmental factors such as geographical, social-economic, or cultural factors. Geographical questions may include questions related to the birth location, family migration history, town, or city of current or past residence. Social-economic questions may be related to education level, income, occupations, and/or self-identified demographic groups. Questions related to culture may concern native language, language spoken at home, customs, and/or dietary practices. Other questions related to cultural and behavioral questions are also possible.

For any survey questions asked, the computing server 1000 may also ask an individual the same or similar questions regarding the traits and environmental factors of the ancestors, family members, other relatives or friends of the individual. For example, the computing server 1000 may ask about the native language of the user account and the native languages of parents and grandparents. The computing server 1000 may also ask about the health history of family members.

In addition to storing the survey data in the individual profile store 1006, the computing server 1000 may store some responses that correspond to data related to genealogical and genetics respectively to genealogy data store 1002 and genetic data store 1004.

The user account profile data, photos of user accounts, survey response data, the genetic data, and the genealogy data may be subject to the privacy and authorization setting of the user accounts to specify any data related to the user accounts that can be accessed, stored, obtained, or otherwise used. For example, when presented with a survey question, a user account may select to answer or skip the question. The computing server 1000 may present user accounts from time-to-time information regarding user accounts' selection of the extent of information and data shared. The computing server 1000 also may maintain and enforce one or more privacy settings for user accounts in connection with the access of the user account profile data, photos, genetic data, and other sensitive data. For example, the user account may pre-authorize the access to the data and may change the setting as wished. The privacy settings also may allow a user account to specify (e.g., by opting out, by not opting in) whether the computing server 1000 may receive, collect, log, or store particular data associated with the user account for any purpose. A user account may restrict her data at various levels. For example, on one level, the data may not be accessed by the computing server 1000 for purposes other than displaying the data in the user account's own profile. On another level, the user account may authorize anonymization of her data and participate in studies and research conducted by the computing server 1000 such as a large-scale genetic study. On yet another level, the user account may tum some portions of her genealogy data public to allow the user account to be discovered by other user accounts (e.g., potential relatives) and be connected to one or more family trees. Access or sharing of any information or data in the computing server 1000 may also be subject to one or more similar privacy policies. Data and content objects in the computing server 1000 may also be associated with different levels of restriction. The computing server 1000 may also provide various notification features to inform and remind user accounts of their privacy and access settings. For example, when privacy settings

for a data entry allow a particular user account or other entities to access the data, the data may be described as being "visible," "public," or other suitable labels, contrary to a "private" label.

In some cases, the computing server 1000 may have a heightened privacy protection on certain types of data and data related to certain vulnerable groups. In some cases, the heightened privacy settings may strictly prohibit the use, analysis, and sharing of data related to a certain vulnerable group. In other cases, the heightened privacy settings may specify that data subject to those settings require prior approval for access, publication, or other use. In some cases, the computing server 1000 may provide the heightened privacy as a default setting for certain types of data, such as genetic data or any data that the user account marks as sensitive. The user account may opt in to sharing of those data or change the default privacy settings. In other cases, the heightened privacy settings may apply across the board for all data of certain groups of user accounts. For example, if computing server 1000 determines that the user account is a minor or has recognized that a picture of a minor is uploaded, the computing server 1000 may designate all profile data associated with the minor as sensitive. In those cases, the computing server 1000 may have one or more extra steps in seeking and confirming any sharing or use of the sensitive data.

The sample pre-processing engine 1008 receives and pre-processes data received from various sources to change the data into a format used by the computing server 1000. For genealogy data, the sample pre-processing engine 1008 may receive data from an individual. To collect the user account data (e.g., genealogical and survey data), the computing server 1000 may cause an interactive user account interface on a client device to display interface elements in which user accounts can provide genealogy data and survey data. Additional data may be obtained from scans of public records. The data may be manually provided or automatically extracted via, for example, optical character recognition (OCR) performed on census records, town or government records, or any other item of printed or online material. Some records may be obtained by digitalizing written records such as older census records, birth certificates, and/or death certificates.

The sample pre-processing engine 1008 may also receive raw data from a genetic data extraction service server. A genetic data extraction service server may perform laboratory analysis of biological samples of user accounts and generate sequencing results in the form of digital data. The sample pre-processing engine 1008 may receive the raw genetic datasets from the genetic data extraction service server. Most of the mutations that are passed down to descendants are related to single-nucleotide polymorphism (SNP). SNP is a substitution of a single nucleotide that occurs at a specific position in the genome. The sample pre-processing engine 1008 may convert the raw base pair sequence into a sequence of genotypes of target SNP sites. Alternatively, the pre-processing of this conversion may be performed by the genetic data extraction service server. The sample pre-processing engine 1008 identifies autosomal SNPs in an individual's genetic dataset. In some embodiments, the SNPs may be autosomal SNPs. In some embodiments, 700,000 SNPs may be identified in an individual's data and may be stored in genetic data store 1004. Alternatively, in some embodiments, a genetic dataset may include at least 10,000 SNP sites. In another embodiment, a genetic dataset may include at least 100,000 SNP sites. In yet another embodiment, a genetic dataset may include at least 400,000 SNP sites. In yet another embodiment, a genetic dataset may include at least 1,000,000 SNP sites. The sample preprocessing engine 1008 may also convert the nucleotides into bits. The identified SNPs, in bits or in other suitable formats, may be provided to the phasing engine 1010 which phases the individual's diploid genotypes to generate a pair of haplotypes for each user account.

The phasing engine 1010 phases diploid genetic dataset into a pair of haploid genetic datasets and may perform imputation of SNP values at certain sites whose alleles are missing. An individual's haplotype may refer to a collection of alleles (e.g., a sequence of alleles) that are inherited from a parent.

Phasing may include a process of determining the assignment of alleles (particularly heterozygous alleles) to chromosomes. Owing to sequencing conditions and other constraints, a sequencing result often includes data regarding a pair of alleles at a given SNP locus of a pair of chromosomes but may not be able to distinguish which allele belongs to which specific chromosome. The phasing engine 1010 uses a genotype phasing algorithm to assign one allele to a first chromosome and another allele to another chromosome. The genotype phasing algorithm may be developed based on an assumption of linkage disequilibrium (LD), which states that haplotype in the form of a sequence of alleles tends to cluster together. The phasing engine 1010 is configured to generate phased sequences that are also commonly observed in many other samples. Put differently, haplotype sequences of different individuals tend to cluster together. A haplotype-cluster model may be generated to determine the probability distribution of a haplotype that includes a sequence of alleles. The haplotype-cluster model may be trained based on labeled data that includes known phased haplotypes from a trio (parents and a child). A trio is used as a training sample because the correct phasing of the child is almost certain by comparing the child's genotypes to the parent's genetic datasets. The haplotype-cluster model may be generated iteratively along with the phasing process with a large number of unphased genotype datasets. The haplotype cluster model may also be used to impute one or more missing data.

By way of example, the phasing engine 1010 may use a directed acyclic graph model such as a hidden Markov model (HMM) to perform the phasing of a target genotype dataset. The directed acyclic graph may include multiple levels, each level having multiple nodes representing different possibilities of haplotype clusters. An emission probability of a node, which may represent the probability of having a particular haplotype cluster given an observation of the genotypes may be determined based on the probability distribution of the haplotype-cluster model. A transition probability from one node to another may be initially assigned to a non-zero value and be adjusted as the directed acyclic graph model and the haplotype-cluster model are trained. Various paths are possible in traversing different levels of the directed acyclic graph model. The phasing engine 1010 determines a statistically likely path, such as the most probable path or a probable path that is at least more likely than 95% of other possible paths, based on the transition probabilities and the emission probabilities. A suitable dynamic programming algorithm such as the Viterbi algorithm may be used to determine the path. The determined path may represent the phasing result. U.S. Patent No. 10,679,729, entitled "Haplotype Phasing Models," granted on Jun. 9, 2020, describes example embodiments of haplotype phasing. Other example phasing embodiments are described in U.S. Patent Application Publication No. US 2021/0034647 A1, entitled "Clustering of Matched Segments to Determine Linkage of Dataset in a Database," published on Feb. 4, 2021.

The IBD estimation engine 1012 estimates the amount of shared genetic segments between a pair of individuals based on phased genotype data (e.g., haplotype datasets) that are stored in the genetic data store 1004. IBD segments may be segments identified in a pair of individuals that are putatively determined to be inherited from a common ancestor. The IBD estimation engine 1012 retrieves a pair of haplotype datasets for each individual. The IBD estimation engine 1012 may divide each haplotype dataset sequence into a plurality of windows. Each window may include a fixed number of SNP sites (e.g., about 100 SNP sites). The IBD estimation engine 1012 identifies one or more seed windows in which the alleles at all SNP sites in at least one of the phased haplotypes between two individuals are identical. The IBD estimation engine 1012 may expand the match from the seed windows to nearby windows until the matched windows reach the end of a chromosome or until a homozygous mismatch is found, which indicates the mismatch is not attributable to potential errors in phasing or imputation. The IBD estimation engine 1012 determines the total length of matched segments, which may also be referred to as IBD segments. The length may be measured in the genetic distance in the unit of centimorgans (cM). A unit of centimorgan may be a genetic length. For example, two genomic positions that are one cM apart may have a 1% chance during each meiosis of experiencing a recombination event between the two positions. The computing server 1000 may save data regarding individual pairs who share a length of IBD segments exceeding a predetermined threshold (e.g., 6 cM), in a suitable data store such as in the genealogy data store 1002. U.S. Patent No. 10,114,1022, entitled "Identifying Ancestral Relationships Using a Continuous stream of Input," granted on Oct. 30, 2018, and U.S. Patent No. 10,720,229, entitled "Reducing Error in Predicted Genetic Relationships," granted on Jul.21, 2020, describe example embodiments of IBD estimation.

Typically, individuals who are closely related share a relatively large number of IBD segments, and the IBD segments tend to have longer lengths (individually or in aggregate across one or more chromosomes). In contrast, individuals who are more distantly related share relatively fewer IBD segments, and these segments tend to be shorter (individually or in aggregate across one or more chromosomes). For example, while close family members often share upwards of 71 cM of IBD (e.g., third cousins), more distantly related individuals may share less than 12 cM of IBD. The extent of relatedness in terms of IBD segments between two individuals may be referred to as IBD affinity. For example, the IBD affinity may be measured in terms of the length of IBD segments shared between two individuals.

Community assignment engine 1014 assigns individuals to one or more genetic communities based on the genetic data of the individuals. A genetic community may correspond to an ethnic origin or a group of people descended from a common ancestor. The granularity of genetic community classification may vary depending on embodiments and methods used to assign communities. For example, in some embodiments, the communities may be African, Asian, European, etc. In another embodiment, the European community may be divided into Irish, German, Swedes, etc. In yet another embodiment, the Irish may be further divided into Irish in Ireland, Irish immigrated to America in 1800, Irish immigrated to America in 1902, etc. The community classification may also depend on whether a population is admixed or unadmixed. For an admixed population, the classification may further be divided based on different ethnic origins in a geographical region.

Community assignment engine 1014 may assign individuals to one or more genetic communities based on their genetic datasets using machine-learning models trained by unsupervised learning or supervised learning. In an unsupervised approach, the community assignment engine 1014 may generate data representing a partially connected undirected graph. In this approach, the community assignment engine 1014 represents individuals as nodes. Some nodes are connected by edges whose weights are based on IBD affinity between two individuals represented by the nodes. For example, if the total length of two individuals' shared IBD segments does not exceed a predetermined threshold, the nodes are not connected. The edges connecting two nodes are associated with weights that are measured based on the IBD affinities. The undirected graph may be referred to as an IBD network. The community assignment engine 1014 uses clustering techniques such as modularity measurement (e.g., the Louvain method) to classify nodes into different clusters in the IBD network. Each cluster may represent a community. The community assignment engine 1014 may also determine sub-clusters, which represent sub-communities. The computing server 1000 saves the data representing the IBD network and clusters in the IBD network data store 1016. U.S. Patent No. 10,223,498, entitled "Discovering Population Structure from Patterns of Identity-By-Descent," granted on Mar. 5, 2019, describes example embodiments of community detection and assignment.

The community assignment engine 1014 may also assign communities using supervised techniques. For example, genetic datasets of known genetic communities (e.g., individuals with confirmed ethnic origins) may be used as training sets that have labels of the genetic communities. Supervised machine-learning classifiers, such as logistic regressions, support vector machines, random forest classifiers, and neural networks may be trained using the training set with labels. A trained classifier may distinguish binary or multiple classes. For example, a binary classifier may be trained for each community of interest to determine whether a target individual's genetic dataset belongs or does not belong to the community of interest. A multi-class classifier such as a neural network may also be trained to determine whether the target individual's genetic dataset most likely belongs to one of several possible genetic communities.

Reference panel sample store 1018 stores reference panel samples for different genetic communities. A reference panel sample is a genetic data of an individual whose genetic data is the most representative of a genetic community. The genetic data of individuals with the typical alleles of a genetic community may serve as reference panel samples. For example, some alleles of genes may be over-represented (e.g., being highly common) in a genetic community. Some genetic datasets include alleles that are commonly present among members of the community. Reference panel samples may be used to train various machine-learning models in classifying whether a target genetic dataset belongs to a community, determining the ethnic composition of an individual, and determining the accuracy of any genetic data analysis, such as by computing a posterior probability of a classification result from a classifier.

A reference panel sample may be identified in different ways. In some embodiments, an unsupervised approach in community detection may apply the clustering algorithm recursively for each identified cluster until the sub-clusters contain a number of nodes that are smaller than a threshold (e.g., contains fewer than 1100 nodes). For example, the community assignment engine 1014 may construct a full IBD network that includes a set of individuals represented by nodes and generate communities using clustering techniques. The community assignment engine 1014 may randomly sample a subset of nodes to generate a sampled IBD network. The community assignment engine 1014 may recursively apply clustering techniques to generate communities in the sampled IBD network. The sampling and clustering may be repeated for different randomly generated sampled IBD networks for various runs. Nodes that are consistently assigned to the same genetic community when sampled in various runs may be classified as a reference panel sample. The community assignment engine 1014 may measure the consistency in terms of a predetermined threshold. For example, if a node is classified to the same community 95% (or another suitable threshold) of the times whenever the node is sampled, the genetic dataset corresponding to the individual represented by the node may be regarded as a reference panel sample. Additionally, or alternatively, the community assignment engine 1014 may select N most consistently assigned nodes as a reference panel for the community.

Other ways to generate reference panel samples are also possible. For example, the computing server 1000 may collect a set of samples and gradually filter and refine the samples until high-quality reference panel samples are selected. For example, a candidate reference panel sample may be selected from an individual whose recent ancestors are born at a certain birthplace. The computing server 1000 may also draw sequence data from the Human Genome Diversity Project (HGDP). Various candidates may be manually screened based on their family trees, relatives' birth location, and other quality control. Principal component analysis may be used to create clusters of genetic data of the candidates. Each cluster may represent an ethnicity. The predictions of the ethnicity of those candidates may be compared to the ethnicity information provided by the candidates to perform further screening.

The ethnicity estimation engine 1020 estimates the ethnicity composition of a genetic dataset of a target individual. The genetic datasets used by the ethnicity estimation engine 1020 may be genotype datasets or haplotype datasets. For example, the ethnicity estimation engine 1020 estimates the ancestral origins (e.g., ethnicity) based on the individual's genotypes or haplotypes at the SNP sites. To take a simple example of three ancestral populations corresponding to African, European and Native American, an admixed user account may have nonzero estimated ethnicity proportions for all three ancestral populations, with an estimate such as [0.05, 0.65, 0.30], indicating that the user account's genome is 5% attributable to African ancestry, 65% attributable to European ancestry and 30% attributable to Native American ancestry. The ethnicity estimation engine 1020 generates the ethnic composition estimate and stores the estimated ethnicities in a data store of computing server 1000 with a pointer in association with a particular user account.

In some embodiments, the ethnicity estimation engine 1020 divides a target genetic dataset into a plurality of windows (e.g., about 1100 windows). Each window includes a small number of SNPs (e.g., 400 SNPs). The ethnicity estimation engine 1020 may use a directed acyclic graph model to determine the ethnic composition of the target genetic dataset. The directed acyclic graph may represent a trellis of an inter-window hidden Markov model (HMM). The graph includes a sequence of a plurality of node groups. Each node group, representing a window, includes a plurality of nodes. The nodes represent different possibilities of labels of genetic communities (e.g., ethnicities) for the window. A node may be labeled with one or more ethnic labels. For example, a level includes a first node with a first label representing the likelihood that the window of SNP sites belongs to a first ethnicity and a second node with a second label representing the likelihood that the window of SNPs belongs to a second ethnicity. Each level includes multiple nodes so that there are many possible paths to traverse the directed acyclic graph.

The nodes and edges in the directed acyclic graph may be associated with different emission probabilities and transition probabilities. An emission probability associated with a node represents the likelihood that the window belongs to the ethnicity labeling the node given the observation of SNPs in the window. The ethnicity estimation engine 1020 determines the emission probabilities by comparing SNPs in the window corresponding to the target genetic dataset to corresponding SNPs in the windows in various reference panel samples of different genetic communities stored in the reference panel sample store 1018. The transition probability between two nodes represents the likelihood of transition from one node to another across two levels. The ethnicity estimation engine 1020 determines a statistically likely path, such as the most probable path or a probable path that is at least more likely than 95% of other possible paths, based on the transition probabilities and the emission probabilities. A suitable dynamic programming algorithm such as the Viterbi algorithm or the forward-backward algorithm may be used to determine the path. After the path is determined, the ethnicity estimation engine 1020 determines the ethnic composition of the target genetic dataset by determining the label compositions of the nodes that are included in the determined path. U.S. Patent No. 10,558,1030, entitled "Local Genetic Ethnicity Determination System," granted on Feb. 11, 2020, and U.S. Patent No. 10,692,587, granted on Jun. 23, 2020, entitled "Global Ancestry Determination System" describe different example embodiments of ethnicity estimation.

The front-end interface 1022 displays various results determined by the computing server 1000. The results and data may include the IBD affinity between a user account and another individual, the community assignment of the user account, the ethnicity estimation of the user account, phenotype prediction and evaluation, genealogy data search, family tree and pedigree, relative profile and other information. The front-end interface 1022 may allow user accounts to manage their profile and data trees (e.g., family trees). The user accounts may view various public family trees stored in the computing server 1000 and search for individuals and their genealogy data via the front-end interface 1022. The computing server 1000 may suggest or allow the user account to manually review and select potentially related individuals (e.g., relatives, ancestors, close family members) to add to the user account's data tree. The front-end interface 1022 may be a graphical user account interface (GUI) that displays various information and graphical elements. The front-end interface 1022 may take different forms. In one case, the front-end interface 1022 may be a software application that can be displayed on an electronic device such as a computer or a smartphone. The software application may be developed by the entity controlling the computing server 1000 and be downloaded and installed on the client device(s) 114. In another case, the front-end interface 1022 may take the form of a webpage interface of the computing server 1000 that allows user accounts to access their family tree and genetic analysis results through web browsers. In yet another case, the front-end interface 1022 may provide an application program interface (API).

The tree management engine 1024 performs computations and other processes related to user accounts' management of their data trees such as family trees. The tree management engine 1024 may allow a user account to build a data tree from scratch or to link the user account to existing data trees. In some embodiments, the tree management engine 1024 may suggest a connection between a target individual and a family tree that exists in the family tree database by identifying potential family trees for the target individual and identifying one or more most probable positions in a potential family tree. A user account (target individual) may wish to identify family trees to which he or she may potentially belong. Linking a user account to a family tree or building a family may be performed automatically, manually, or using techniques with a combination of both. In an embodiment of an automatic tree matching, the tree management engine 1024 may receive a genetic dataset from the target individual as input and search related individuals that are IBO-related to the target individual. The tree management engine 1024 may identify common ancestors. Each common ancestor may be common to the target individual and one of the related individuals. The tree management engine 1024 may in turn output potential family trees to which the target individual may belong by retrieving family trees that include a common ancestor and an individual who is IBO-related to the target individual. The tree management engine 1024 may further identify one or more probable positions in one of the potential family trees based on information associated with matched genetic data between the target individual and DNA test takers in the potential family trees through one or more machine-learning models or other heuristic algorithms. For example, the tree management engine 1024 may try putting the target individual in various possible locations in the family tree and determine the highest probability position(s) based on the genetic datasets of the target individual and other DNA test takers in the family tree and based on genealogy data available to the tree management engine 1024. The tree management engine 1024 may provide one or more family trees from which the target individual may select. For a suggested family tree, the tree management engine 1024 may also provide information on how the target individual is related to other individuals in the tree. In a manual tree building, a user account may browse through public family trees and public individual entries in the genealogy data store 1002 and individual profile store 1006 to look for potential relatives that can be added to the user account's family tree. The tree management engine 1024 may automatically search, rank, and suggest individuals for the user account conduct manual reviews as the user account makes progress in the front-end interface 1022 in building the family tree.

As used herein, "pedigree" and "family tree" may be interchangeable and may refer to a family tree chart or pedigree chart that shows, diagrammatically, family information, such as family history information, including parentage, offspring, spouses, siblings, or otherwise for any suitable number of generations and/or people, and/or data pertaining to persons represented in the chart. U.S. Patent No. 11,429,615, entitled "Linking Individual Datasets to a Database," granted on Aug. 30, 2022, describes example embodiments of how an individual may be linked to existing family trees.

The components of the user-generated-content system 106 can include software, hardware, or both. For example, the components of the user-generated-content system 106 can include one or more instructions stored on a computer-readable storage medium and executable by processors of one or more computing devices. When executed by one or more processors, the computer-executable instructions of the user-generated-content system 106 can cause a computing device to perform the methods described herein. Alternatively, the components of the user-generated-content system 106 can comprise hardware, such as a special purpose processing device to perform a certain function or group of functions. Additionally, or alternatively, the components of the user-generated-content system 106 can include a combination of computer-executable instructions and hardware.

Furthermore, the components of the user-generated-content system 106 performing the functions described herein may, for example, be implemented as part of a stand-alone application, as a module of an application, as a plug-in for applications including content management applications, as a library function or functions that may be called by other applications, and/or as a cloud-computing model. Thus, the components of the user-generated-content system 106 may be implemented as part of a stand-alone application on a personal computing device or a mobile device.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 11 illustrates a block diagram of an example computing device 1100 that may be configured to perform one or more of the processes described above. One will appreciate that one or more computing devices, such as the computing device 1100 may represent the computing devices described above (e.g., server device(s) 102, database 112, client device(s) 114, third-party server(s) 118, and computing server 1000). In one or more embodiments, the computing device 1100 may be a mobile device (e.g., a mobile telephone, a smartphone, a PDA, a tablet, a laptop, a camera, a tracker, a watch, a wearable device, etc.). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 includes storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

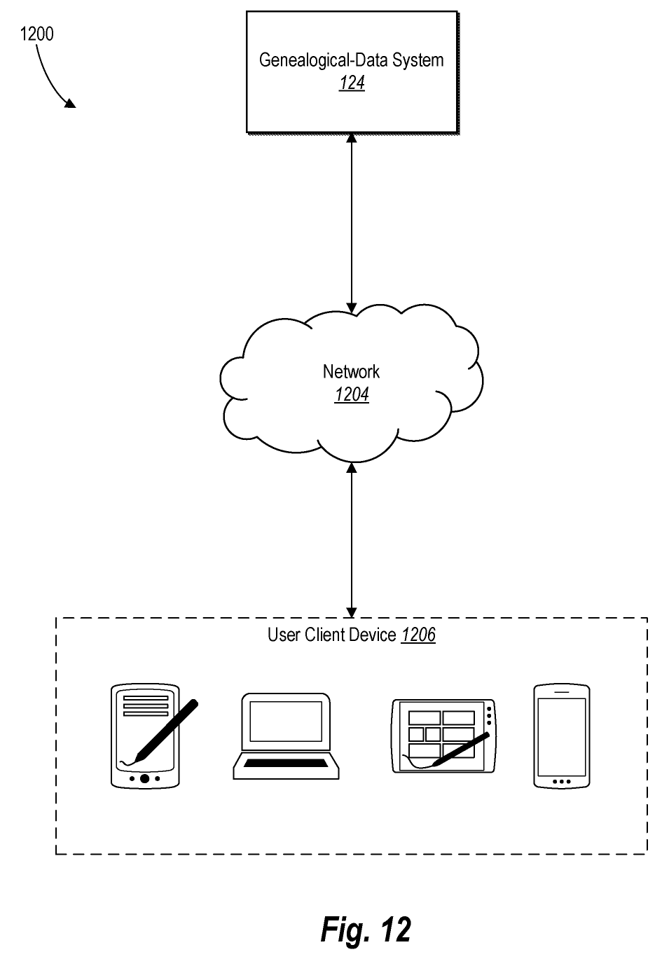

FIG. 12 illustrates a schematic diagram of environment 1200 within which one or more implementations of the user-generated-content system 106 can be implemented. For example, the user-generated-content system 106 may be part of a genealogical-data system 104. The genealogical-data system 104 may generate, store, manage, receive, and send digital content (such as genealogical digital images). For example, genealogical-data system 104 may send and receive digital content to and from client devices 1206 by way of network 1204. In particular, genealogical-data system 104 can store and manage genealogical databases for various user accounts, historical records, and genealogical trees. In some embodiments, the genealogical-data system 104 can manage the distribution and sharing of digital content between computing devices associated with user accounts. For instance, the genealogical-data system 104 can facilitate a user account sharing a genealogical digital image with another user account of genealogical-data system 104.

In particular, the genealogical-data system 104 can manage synchronizing digital content across multiple client devices 1206 associated with one or more user accounts. For example, a user may edit a digitized historical document or a node within a genealogical tree using client device 1206. The genealogical-data system 104 can cause client device 1206 to send the edited genealogical content to the genealogical-data system 104, whereupon the genealogical-data system 104 synchronizes the genealogical content on one or more additional computing devices.

As shown, the client device 1206 may be a desktop computer, a laptop computer, a tablet computer, an augmented reality device, a virtual reality device, a personal digital assistant (PDA), an in- or out-of-car navigation system, a handheld device, a smart phone or other cellular or mobile phone, or a mobile gaming device, other mobile device, or other suitable computing devices. The client device 1206 may execute one or more client applications, such as a web browser (e.g., Microsoft Windows Internet Explorer, Mozilla Firefox, Apple Safari, Google Chrome, Opera, etc.) or a native or special-purpose client application (e.g., Ancestry: Family History & DNA for iPhone or iPad, Ancestry: Family History & DNA for Android, etc.), to access and view content over the network 1204.

The network 1204 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1206 may access genealogical-data system 104.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving a digital image depicting a generated genealogical-content item from a client device associated with a genealogical-data system;
generating, using a content-classification machine-learning model to process the digital image, a record classification for the generated genealogical-content item;
extracting, using a genealogical-data-extracting machine-learning pipeline, genealogical data from the generated genealogical-content item based on the record classification; and
generating, from the genealogical data, a genealogical record comprising the genealogical data reflected in the generated genealogical-content item.

2. The computer-implemented method of claim 1, wherein the generated genealogical-content item is a user-generated content item.

3. The computer-implemented method of claim 1, wherein extracting the genealogical data from the generated genealogical-content item further comprises:
generating, using a layout-detection machine-learning model, layout data for the generated genealogical-content item; and
extracting, using the genealogical-data-extracting machine-learning pipeline, the genealogical data from the generated genealogical-content item based on the layout data.

4. The computer-implemented method of claim 1, wherein generating the record classification further comprises:
generating, using the content-classification machine-learning model of the genealogical-data-extracting machine-learning pipeline, predicted region boundaries indicating sections of handwritten content in the generated genealogical-content item; and
generating, using the content-classification machine-learning model, the record classification for the generated genealogical-content item based on the predicted region boundaries corresponding to region boundaries for a predetermined record classification.

5. The computer-implemented method of claim 1, further comprising:
extracting the genealogical data by generating, using a transcription machine-learning model of the genealogical-data-extracting machine-learning pipeline, a transcription of handwritten text in the generated genealogical-content item;
generating the genealogical record comprising at least a portion of the transcription of the handwritten text in the generated genealogical-content item; and
modifying a genealogical database using the genealogical record.

6. The computer-implemented method of claim 1, further comprising:
extracting the genealogical data by generating, using a segmentation machine-learning model of the genealogical-data-extracting machine-learning pipeline, one or more segments for the generated genealogical-content item;
generating the genealogical record based on the one or more segments for the generated genealogical-content item; and
modifying a genealogical database using the genealogical record.

7. The computer-implemented method of claim 1, further comprising:
extracting the genealogical data by generating, using a topic-identifying machine-learning model of the genealogical-data-extracting machine-learning pipeline, a topic for the generated genealogical-content item;
generating the genealogical record based on the topic for the generated genealogical-content item; and
modifying a genealogical database using the genealogical record.

8. The computer-implemented method of claim 1, further comprising:
extracting the genealogical data by extracting, using an entity-extracting machine-learning model of the genealogical-data-extracting machine-learning pipeline, one or more entities reflected in the generated genealogical-content item;
generating the genealogical record comprising the one or more entities reflected in the generated genealogical-content item; and
modifying a genealogical database using the genealogical record.

9. The computer-implemented method of claim 1, further comprising:
extracting the genealogical data by extracting, using a content-extracting machine-learning model of the genealogical-data-extracting machine-learning pipeline, structured genealogical data reflected in the generated genealogical-content item;
generating the genealogical record comprising the structured genealogical data reflected in the generated genealogical-content item; and
modifying a genealogical database using the genealogical record.

10. A non-transitory computer-readable medium storing instructions that, when executed by at least one processor, cause a computer system to:
receive a digital image depicting a generated genealogical-content item from a client device associated with a genealogical-data system;
generate, using a content-classification machine-learning model to process the digital image, a record classification for the generated genealogical-content item;
extract, using a genealogical-data-extracting large language model, genealogical data from the generated genealogical-content item based on the record classification; and
generate, from the genealogical data, a genealogical record comprising the genealogical data reflected in the generated genealogical-content item.

11. The non-transitory computer-readable medium of claim 10, wherein the generated genealogical-content item is a user-generated genealogical content item.

12. The non-transitory computer-readable medium of claim 10, further comprising instructions that, when executed by the at least one processor, cause the computer system to:
generate, using a layout-detection machine-learning model, layout data for the generated genealogical-content item; and
extracting, using the genealogical-data-extracting large language model, the genealogical data from the generated genealogical-content item based on the layout data.

13. The non-transitory computer-readable medium of claim 10, further comprising instructions that, when executed by the at least one processor, cause the computer system to generate the record classification by:
generating, using the content-classification machine-learning model, predicted region boundaries indicating sections of handwritten content in the generated genealogical-content item; and
generating, using the content-classification machine-learning model, the record classification for the generated genealogical-content item based on the predicted region boundaries corresponding to region boundaries for a predetermined record classification.

14. The non-transitory computer-readable medium of claim 10, further comprising instructions that, when executed by the at least one processor, cause the computer system to:
extract the genealogical data by generating, using the genealogical-data-extracting large language model, a transcript of handwritten text reflected in the generated genealogical-content item;
generating the genealogical record comprising at least a portion of the transcript of the handwritten text reflected in the generated genealogical-content item; and
modify a genealogical database using the genealogical record.

15. The non-transitory computer-readable medium of claim 10, further comprising instructions that, when executed by the at least one processor, cause the computer system to:
extract the genealogical data by extracting, using the genealogical-data-extracting large language model, one or more entities reflected in the generated genealogical-content item;
generate the genealogical record comprising the one or more entities reflected in the generated genealogical-content item; and
modify a genealogical database using the genealogical record.

16. A system comprising:
at least one processor; and
at least one non-transitory computer-readable storage medium storing instructions that, when executed by the at least one processor, cause the system to:
receive a digital image depicting a generated genealogical-content item from a client device associated with a genealogical-data system;
generate, using a content-classification machine-learning model to process the digital image, a record classification for the generated genealogical-content item;
extract, using a genealogical-data-extracting machine-learning model specific to the record classification, genealogical data from the generated genealogical-content item based on layout data for the generated genealogical-content item; and
generate, from the genealogical data, a genealogical record comprising the genealogical data reflected in the generated genealogical-content item.

17. The system of claim 16, wherein the generated genealogical-content item is a user-generated genealogical-content item.

18. The system of claim 16, further comprising instructions that, when executed by the at least one processor, cause the system to generate the genealogical-data-extracting machine-learning model specific to the record classification by training a machine-learning model using digital images comprising generated genealogical-content items corresponding to the record classification.

19. The system of claim 16, further comprising instructions that, when executed by the at least one processor, cause the system to extract the genealogical data from the generated genealogical-content item based on the layout data for the generated genealogical-content item by:
generating the layout data based on using a layout-detection machine-learning model to generate bounding box predictions for the generated genealogical-content item; and
extracting the genealogical data from the generated genealogical-content item based on the bounding box predictions.

20. The system of claim 16, further comprising instructions that, when executed by the at least one processor, cause the system to:
extract the genealogical data by extracting, using an entity-extracting machine-learning model, one or more entities reflected in the generated genealogical-content item;
generate the genealogical record comprising the one or more entities reflected in the generated genealogical-content item; and
modify a genealogical database using the genealogical record.
